(19) United States
(12) Patent Application Publication
(10) Pub. No.: US 2025/0363913 A1
(43) Pub. Date: Nov. 27, 2025

(54) ADAPTIVE LANGUAGE LEARNING ENVIRONMENTS

(71) Applicant: Benjamin Parker Spindt, Menlo Park, CA (US)

(72) Inventor: Benjamin Parker Spindt, Menlo Park, CA (US)

(21) Appl. No.: 19/211,962

(22) Filed: May 19, 2025

Related U.S. Application Data
(60) Provisional application No. 63/650,985, filed on May 23, 2024.

(51) Int. Cl. G09B 19/06; G09B 5/06

(52) U.S. Cl. CPC G09B 19/06; G09B 5/06

(57) ABSTRACT

Systems and methods are described that may include an adaptive language learning system including at least one processor; and memory storing instructions that when executed by the at least one processor cause the at least one processor to perform operations including: receiving an input from a user in a user interface, the input comprising a topic and a language; generating, based on the topic and a repository of language data having rules and collections of words and phrases associated with the language, interactive content pertaining to at least one lesson for learning the language; receiving interactions from the user with at least a portion of the interactive content; determining, based on the interactions, a knowledge level of the user with respect to language skills associated with the language; and generating, based on the determined knowledge level, one or more selectable indications comprising a suggested difficulty level.

### CROSS-REFERENCE TO RELATED APPLICATION

This application is a continuation of U.S. Provisional Application No. 63/650,985, titled “Adaptive Language Learning Environments,” filed May 23, 2024, the contents of which are herein incorporated by reference in their entirety.

### TECHNICAL FIELD

The present disclosure relates to generating software for custom artificial intelligence (AI) content generation associated with language learning and teaching.

### BACKGROUND

Finding content specifically tailored to a person's level and interests is a difficult task. People have a wide range of interests, and the volume of content at each level of competency defined at a granular level tends to be limited, especially at intermediate levels. In classroom and tutoring environments, creating content by hand is difficult and time consuming, particularly when trying to weigh the varying interests and knowledge of many students or customers. Furthermore, when trying to understand content in the target language, a student will come across words and grammar that they do not remember or have yet to learn. Searching for information and help to overcome these difficulties is highly disruptive to content consumption and can lead to a substantial part of the study time being devoted to searching for information and resources.

### SUMMARY

In general, systems and methods described herein may include a learning environment that may be targeted at students (e.g., learners, users) of any level. The learning environment can generate language based content tailored to a level in which a student is determined to be learning or which the student selects. The learning environment may further provide resources to aid the student in understanding the content or related data in real time. In some examples, the learning environment may incorporate Artificial Intelligence (AI) to generate content tailored to a level of difficulty on a student-selected topic. In some examples, an Interactive Reader can further be used with the learning environment to provide information to the student, such as translations, definitions, grammar information, text-to-speech experiences, study tools such as digital flash cards, outlines, etc. In some examples, the learning environment may incorporate such generated content and/or tools described herein as a way to optimize the performance of each of the tools for one or more users or user types.

In some aspects, the techniques described herein relate to an adaptive language learning system including: at least one processor; and memory storing instructions that when executed by the at least one processor cause the at least one processor to perform operations including: receiving an input from a user in a user interface, the input including a topic and a language; generating, based on the topic and a repository of language data having rules and collections of words and phrases associated with the language, interactive content pertaining to at least one lesson for learning the language; receiving, in the user interface, interactions from the user with at least a portion of the interactive content; determining, based on the interactions, a knowledge level of the user with respect to language skills associated with the language; and generating, based on the determined knowledge level, one or more selectable indications including a suggested difficulty level at which to continue the at least one lesson or a suggested difficulty level for users to target when selecting content or requesting AI-generated supplemental content.

In some aspects, the techniques described herein relate to a system, wherein determining the knowledge level of the user is based at least in part on one or both of: a user inputted rating of words or phrases within the interactive content; and a user inputted rating of understanding of portions of the interactive content.

In some aspects, the techniques described herein relate to a system, further including: modifying the suggested difficulty level for the interactive content or the supplemental content in response to receiving selection on the one or more selectable indications.

In some aspects, the techniques described herein relate to a system, wherein the repository of language data for collections of words and phrases associated with the language is generated by an artificial intelligence model and includes data indicating a frequency of use of one or more word or phrase in the collections of words and phrases, data indicating a determined level of confidence of the user for one or more of the collections of words and phrases, definition data for one or more of the collections of words and phrases, and data indicating related topics to one or more of the collections of words and phrases.

In some aspects, the techniques described herein relate to a system, further including an interactive reader communicatively coupled to an artificial intelligence model and configured to: analyze, based on the language, the generated interactive content to generate information about lemmas, definitions, grammatical function, and morphological characteristics; and present related content in the user interface, based on the analyzing of the generated interactive content, in coordination with user gestures or in an automated progression over time through the at least one lesson.

In some aspects, the techniques described herein relate to a system, wherein the related content includes one or more of: a conjugation of a word, a definition of a word, a grammatical gender of a word, a declension of a word, an audible utterance of one or more words, and a visual indicator on the one or more words, and wherein the interactive reader provides text to speech function for output in conjunction with the related content and the interactive content.

In some aspects, the techniques described herein relate to a system, further including a study materials generator communicatively coupled to an artificial intelligence model configured to generate a plurality of study materials responsive to user selection of a word, a phrase, or a portion of content in the interactive content.

In some aspects, the techniques described herein relate to a system, wherein the plurality of study materials include: user interface content including dynamic explanations for grammar and word usage of the selected word, phrase, or portion of the generated supplemental content; user interface content including tables indicating forms of the selected word or phrase; and one or more virtual flash cards.

In some aspects, the techniques described herein relate to a system, wherein the one or more virtual flash cards are collected over time and presented in the user interface.

In some aspects, the techniques described herein relate to a non-transitory computer-readable medium for teaching language in an adaptive language learning system, including: at least one processor; and a memory storing instructions that, when executed by the at least one processor, cause the at least one processor to perform operations including: receiving an input from a user in a user interface, the input including a topic and a language; generating, based on the topic and a repository of language data having rules and collections of words and phrases associated with the language, interactive content pertaining to at least one lesson for learning the language; receiving, in the user interface, interactions from the user with at least a portion of the interactive content; determining, based on the interactions, a knowledge level of the user with respect to language skills associated with the language; and generating, based on the determined knowledge level, one or more selectable indications including a suggested difficulty level at which to continue the at least one lesson or a suggested difficulty level for users to target when selecting content or requesting AI-generated supplemental content.

In some aspects, the techniques described herein relate to a computer-readable medium, wherein determining the knowledge level of the user is based at least in part on one or both of: a user inputted rating of words or phrases within the interactive content; and a user inputted rating of understanding of portions of the interactive content.

In some aspects, the techniques described herein relate to a computer-readable medium, wherein the operations further include: modifying the suggested difficulty level for the interactive content or the supplemental content in response to receiving selection on the one or more selectable indications.

In some aspects, the techniques described herein relate to a computer-readable medium, wherein the repository of language data for collections of words and phrases associated with the language is generated by an artificial intelligence model and includes data indicating a frequency of use of one or more word or phrase in the collections of words and phrases, data indicating a determined level of confidence of the user for one or more of the collections of words and phrases, definition data for one or more of the collections of words and phrases, and data indicating related topics to one or more of the collections of words and phrases.

In some aspects, the techniques described herein relate to a computer-readable medium, further including an interactive reader communicatively coupled to an artificial intelligence model and configured to: analyze, based on the language, the generated interactive content to generate information about lemmas, definitions, grammatical function, and morphological characteristics; and present related content in the user interface, based on the analyzing of the generated interactive content, in coordination with user gestures or in an automated progression over time through the at least one lesson.

In some aspects, the techniques described herein relate to a computer-readable medium, wherein the related content includes one or more of: a conjugation of a word, a definition of a word, a grammatical gender of a word, a declension of a word, an audible utterance of one or more words, and a visual indicator on the one or more words, and wherein the interactive reader provides text to speech function for output in conjunction with the related content and the interactive content. 16.

In some aspects, the techniques described herein relate to a computer-implemented method for teaching language in an adaptive language learning system, the method including: at least one processor; and a memory storing instructions that, when executed by the at least one processor, cause the at least one processor to perform operations including: receiving an input from a user in a user interface, the input including a topic and a language; generating, based on the topic and a repository of language data having rules and collections of words and phrases associated with the language, interactive content pertaining to at least one lesson for learning the language; receiving, in the user interface, interactions from the user with at least a portion of the interactive content; determining, based on the interactions, a knowledge level of the user with respect to language skills associated with the language; and generating, based on the determined knowledge level, one or more selectable indications including a suggested difficulty level at which to continue the at least one lesson or a suggested difficulty level for users to target when selecting content or requesting AI-generated supplemental content.

In some aspects, the techniques described herein relate to a computer-implemented method, wherein determining the knowledge level of the user is based at least in part on one or both of: a user inputted rating of words or phrases within the interactive content; and a user inputted rating of understanding of portions of the interactive content.

In some aspects, the techniques described herein relate to a computer-implemented method, wherein the operations further include: modifying the suggested difficulty level for the interactive content or the supplemental content in response to receiving selection on the one or more selectable indications.

In some aspects, the techniques described herein relate to a computer-implemented method, wherein the repository of language data for collections of words and phrases associated with the language is generated by an artificial intelligence model and includes data indicating a frequency of use of one or more word or phrase in the collections of words and phrases, data indicating a determined level of confidence of the user for one or more of the collections of words and phrases, definition data for one or more of the collections of words and phrases, and data indicating related topics to one or more of the collections of words and phrases.

In some aspects, the techniques described herein relate to a computer-readable medium, further including an interactive reader communicatively coupled to an artificial intelligence model and configured to: analyze, based on the language, the generated interactive content to generate information about lemmas, definitions, grammatical function, and morphological characteristics; and present related content in the user interface, based on the analyzing of the generated interactive content, in coordination with user gestures or in an automated progression over time through the at least one lesson.

In some aspects, the techniques described herein relate to a computer-implemented method, wherein the related content includes one or more of: a conjugation of a word, a definition of a word, a grammatical gender of a word, a declension of a word, an audible utterance of one or more words, and a visual indicator on the one or more words, and wherein the interactive reader provides text to speech function for output in conjunction with the related content and the interactive content.

In some aspects, the techniques described herein relate to a computer-implemented method, further including a study materials generator communicatively coupled to an artificial intelligence model configured to generate a plurality of study materials responsive to user selection of a word, a phrase, or a portion of content in the interactive content.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1A is a block diagram illustrating an example learning environment for teaching users one or more foreign languages.

FIG. 1B is a block diagram illustrating an example framework of the learning environment described herein.

FIG. 2 is an example screenshot of an embodiment of a main menu available in application where the current target language is specified in the title.

FIG. 3 is an example screenshot of an embodiment of a top level menu for lessons.

FIG. 4 is an example screenshot of an embodiment of a submenu for lessons.

FIG. 5 is a set of example screenshots of an embodiment of a menu for a lesson on a particular topic.

FIG. 6 depicts example screenshots of an embodiment of lessons which feature menu items for interacting with and generating content.

FIG. 7A is an example screenshot of a text input field interface for telling the application the topic about which the user wants content.

FIG. 7B is an example screenshot of a view that is shown once the AI generator has created the requested content.

FIG. 8A is an example screenshot of an interactive reader module.

FIG. 8B depicts example screenshots of an embodiment for how tools are incorporated and the study material generator's data interacted with within the interactive reader module.

FIG. 9 depicts example screenshots of further examples of the kind of data that may be displayed in the interactive reader information scrollable view.

FIG. 10 is an example screenshot of an embodiment of the interactive reader module interacting with study tools.

FIG. 11A depicts example screenshots of one embodiment of an integration of a flash card study tool into the interactive reader module.

FIG. 11B depicts example screenshots of embodiments of use of a flash card study tool that is integrated into an interactive reader module.

FIG. 12 depicts example screenshots of an embodiment of one of the study materials, in this instance a conjugation table, which is integrated into the interactive reader module.

FIG. 13A depicts example screenshots of an embodiment of a conjugation table study tool.

FIG. 13B depicts example screenshots of an embodiment of an interface enabling dynamic reusability use of a study tool, in this case a conjugation table, in coordination with the language database.

FIG. 14 depicts example screenshots of an embodiment of a dynamic study tool, in this case a tense formation explanation generator.

FIG. 15 depicts example screenshots of an embodiment of an interface for using tools and modifying the parameters of other modules within the application.

FIG. 16 is an example screenshot of an embodiment of a TTS parameter modifier interface.

FIG. 17 is an example screenshot of an embodiment of a menu for interacting with virtual flash cards.

FIG. 18A is an example screenshot of an embodiment of a flash card review feature.

FIG. 18B is an example screenshot of an embodiment of a flash card review options menu.

FIG. 19 is an example screenshot of an embodiment of the menu for selecting a category whose cards to which you would like to restrict the flash card review.

FIG. 20 is an example screenshot of an embodiment of a rarity level selection menu.

FIG. 21 depicts a set of example screenshots of an embodiment of an interface for looking through a deck of flash cards.

FIG. 22A depicts example screenshots of an embodiment of a card editing menu.

FIG. 22B depicts example screenshots of an embodiment of a menu for editing the categories for a flash card.

FIG. 23 is an example screenshot of an embodiment for a menu for editing and viewing a card the user is permitted to change.

FIG. 24 is an example screenshot of an embodiment for a card text editor and/or creator interface.

FIG. 25 is an example screenshot of an embodiment of a content menu, which may be accessed from a higher menu such as through.

FIG. 26 depicts example screenshots of an embodiment of content library menus.

FIG. 27A is an example screenshot of an embodiment of the interactive reader module in combination with an audio player.

FIG. 27B depicts example screenshots of an embodiment of the study tools and other tools incorporated into a scrollable view with an interactive reader module which is paired with an audio player.

FIG. 28 is a flow chart depicting a process for generating and displaying content in an adaptive language learning system.

FIG. 29 is a set of example screenshots depicting a content creation menu with a selector for a target difficulty level of content.

The illustrated embodiments are merely examples and are not intended to limit the disclosure. The schematics are drawn to illustrate features and concepts and are not necessarily drawn to scale.

### DETAILED DESCRIPTION

Described herein are systems and methods for an adaptive language learning system that may assess a language learning level of a user and generate and adapt instructional content and study materials to the determined language learning level. The systems and methods also provide for interactive reader functionality that may analyze words in the generated instructional content and study materials and generate supporting information including, but not limited to translations, dynamic explanations, definitions, and/or other tools and tables depicting various forms of words. In some embodiments, the adaptive reader may generate and apply indicators to words and/or phrases to infer higher priority for later user review.

The technical problem sought to be solved by the present disclosure is to generate tangible and interactive materials to teach a language in a way that is tailored to a learning level or knowledge level of a user with respect to the language, and determining how to modify such interactive materials as the user improves performance over time. The technical solution provided by the embodiments described herein includes a learning environment that can assess a language knowledge level of a user, generate tailored content and study materials for the user according to the language knowledge level, and iteratively and/or continually adapt the content and study materials for the user as the user progresses through language lessons. The technical solution may provide an advantage of improving, for a user, any or all of: a knowledge retention for a language, a vocabulary memorization retention in the language, and a language fluency rate. For example, the systems and methods described herein may improve knowledge retention and/or vocabulary memorization retention for a user by incorporating study tools such as flash cards into many features of the app or user interface presenting the learning environment. The systems described herein may also allow the user to indicate when the user encounters a word the user understands with ease or alternatively, a word the user may have trouble understanding throughout presented content, ensuring that the user can keep the system up to date on which words are understood and which words cause difficulty. This indication mechanism can function to optimize user experience when reviewing with study tools at a later time. The system may also curate sets of words and phrases filtered based on word/phrase frequency of use, related topics, and/or whether words/phrases are present in a chosen or presented instance of content.

The systems described herein provide an improvement over conventional language systems which typically do not provide ways for the user to inform the user about user-based understanding of words and phrases outside of using the dedicated tools for studying vocabulary. The systems described herein provide another improvement over conventional systems by enabling use of study tools which are limited to the words and phrases that appear in some specific instance of content, which allows the user to study to understand that particular content without having to perform manual work triaging

In another example, the systems and methods described herein may improve a language fluency rate for a user by minimizing the time between encountering unknown or poorly understood concepts, words, or the like, and accessing tools to understand such concepts, words, etc. The systems described herein may also precisely target the user's knowledge level or language abilities and advance difficulty levels of the content presented as the user advances, ensuring that the user is not left behind, unlike in a traditional/conventional system in which the pace at which the material increases in difficulty outpaces user growth/improvements.

Conventional systems lack the ability to rapidly increase language fluency rate because of three factors. First, conventional systems generally create content targeting the interests of a broad audience and at levels of difficulty which go at a set pace that cannot be changed. Second, conventional systems often do not have text to speech and audio in all aspects (or at all), making students unable to build connections between words and how they sound. Finally, conventional systems do not provide easy access (or any access) to meanings, translations, and explanations of grammar, causing long periods of stress and frustration as students in conventional systems will be asked to search around for help, sometimes in vain.

The learning environments described herein represent software applications and/or user interfaces that generate and provide content to language learners (e.g., students, users, etc.) of all levels or one or more specific levels. The content may pertain to a target language or to a concept for learning a target language. The content may also be specifically generated based on one or more user requests or user specific aspects. The content may further include a series of lessons explaining concepts in detail in some embodiments accompanied by flash cards, example content associated with the target language or languages, and/or other study tools. The content may be generated to account for a language learning level of each specific user that may access the learning environment.

In some embodiments, the content may also include one or more libraries of content associated with the target language. In general, the content described herein may be in the form of text, audio, and/or video. In the examples in which the content is arranged in a lesson format, the lessons may be ordered or otherwise arranged to assist a particular user in learning the target language or languages.

The learning environments described herein may also allow the user to request content pertaining to a user-selected topic. For example, the user may select one or more topics and the environments may generate and provide content associated with such topics in one or more lessons (or other outputs) generated for the user and may do so according to the determined language level of the user or a language level requested by the user. For example, based on a user request, a prompt to retrieve content and/or the actual content may be generated to retrieve content at the language level using one or more machine learning models (e.g., AI/ML models 146) and/or Artificial Intelligence (AI) techniques. In some embodiments, AI-generated content can be created without being restricted to the level or context of any specific lesson.

In some embodiments, the learning environment described herein features an Interactive Reader which analyzes words, phrases, or the like in the content and allows the user to access supporting information including, but not limited to translations, dynamic explanations, definitions, tables of forms, study tools, and the like. The learning environment may also automatically (or by user interaction) mark (e.g., flag, highlight, etc.) words as higher priority for later flash card review. The learning environment may also include an audio player, and/or video player along with tools and transcripts integrated into the same environment. The tools may include, but are not limited to tables of forms, dynamic explanation generators, and study content that may be visually and/or audibly provided by the learning environment to a user.

In operation, the learning environment may analyze displayed text while simultaneously allowing the user to change the text size, or read the text out loud, or change which part of the text is being displayed in the environment. The learning environment can also simultaneously load and pass the data associated with a user-selected or automatically selected portion of the content for use in study tools and in an interactive reader interface, while performing tasks such as reading aloud and changing formatting of the selected text (e.g., color, underline, italic, bold, increase text size, decrease text size, etc.). The learning environment may provide such modifications, loading, and transmission of data while providing text to speech functionality to provide the user with on demand information while allowing the environment to continue to learn about user needs and provide additional content to the user. Providing such on demand information via text to speech can allow real time data consumption for learners of a second language to minimize user frustration and/or confusion and to speed the process of learning for the user. Speeding the process may include minimizing user searching time and confusion by providing the information on an as needed basis. Minimizing search time and confusion may provide the advantage of a positive experience for the user while effectively teaching the user language-based concepts.

The learning environment may further include dynamic explanation generators that write explanations for users by using specifically selected instances of a word or phrase to close the learning gap between reading about a general pattern and/or formula and the application of the pattern and/or formula in a specific instance. This may ensure that confusion is avoided because the explanation generator is aware of irregular forms and pattern changes and explicitly provides indicators on such forms and/or changes when the user selects a word or phrase in the target language that may have an explanation that may be irregular in form or pattern.

In some embodiments, the learning environment may also include a flash card review module with an algorithm to show digital cards for words or phrases that the user finds difficult to remember more often than others. The learning environment may also provide the ability to selectively view flash cards representing words, phrases, concepts, or the like depending on how frequently they are used in real life or that relate to some category or topic. In some embodiments, the learning environment may also include several of the same dynamic tools such as tables, definitions and dynamic explanations, etc. outside of the Interactive Reader. The learning environment may further collect the flash cards having content related to the words and/or phrases present in a specific instance or collection of instances of content, with the same algorithm and study tools described herein.

In some embodiments, the learning environment may further include a sandboxed set of flash cards to alleviate user frustration and/or confusion that may occur when reading or hearing a word in which the user does not understand in a specific instance of content. With this sandboxed set of flash cards, the learning environment provides the user with an organized list of all the flash cards relating to the words and/or phrases in which the user will be presented as part of the content. The user can browse through the sandboxed set of flash cards and see how frequently the words and/or phrases are used in general, what categories the words and/or phrases may fall into and a determined level of confidence with the words and/or phrases for a specific user. In some embodiments, the sandboxed set of flash cards may be organized and/or filtered according to rules, user selection, lesson type, and/or other logic. The user can immediately see the words that are new or difficult for them and can use a flash card review module to study and review these cards and all the other cards in the sandbox. This may prime the user to be able to understand much more of the content including new words and/or phrases within the content. Flash cards and the other tools described herein can help minimize the time the user spends confused and frustrated and provide a logical and clear process for learning new words, phrases, and the like by providing such words and/or phrases in custom generated content.

The learning environment described herein may integrate the study tools, the lesson interfaces, content libraries, content generator and interfaces to enable the user to learn quickly, access frequently desired information, and enjoy content on user selected topics in a logical structure that explicitly guides the user through levels of advancement in one or more target languages. Users can advance through lessons in order, review flash cards by order of rarity, generate content tied to the levels of various lessons and access tools to fill gaps in knowledge, provide reminders, and further guide the user.

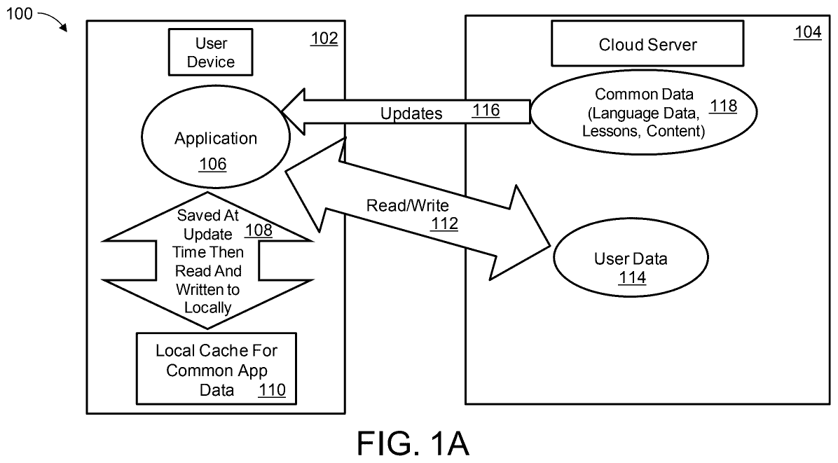

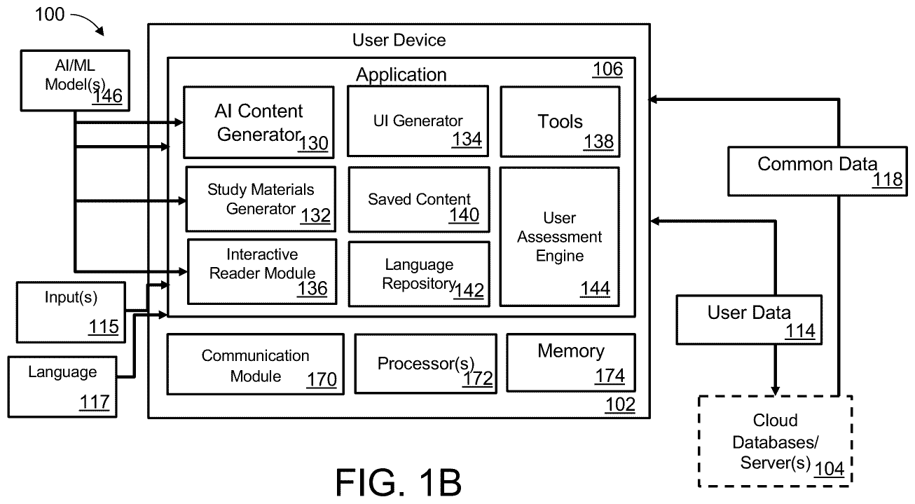

FIG. 1A illustrates a block diagram of an example learning environment 100 for teaching users one or more foreign languages. The learning environment 100 includes a user device 102 in communication with a cloud server 104 (e.g., cloud data, cloud database, or server). The user device 102 may represent one or more computing devices such as a mobile or portable computing device, a laptop device, a tablet device, a smart phone, or any other type of mobile or portable computing device. In some embodiments, the computing device 104 is a stationary computing device, such as a desktop computer or workstation.

The user device 102 may include and/or execute application 106 to provide application content to a user. The application content may be stored content, AI-generated content, user requested content, or any combination thereof. The application 106 may store 108 application data locally in a cache 110. In some embodiments, the application 106 may also read data and/or write 112 user data 114 from user device 102 to cloud server 104. Cloud server 104 may provide one or more updates 116 with any combination of data 118 including, but not limited to word related data (definitions, translations, forms, grammatical gender, frequency of use, categories its related to and the like), lessons, content (e.g., in forms such as text, audio and video), flash card data and/or other forms of data.

In some embodiments, the user of device 102 may enter input(s) 115 and/or language 117 related data into one or more fields of application 106 (e.g., a prompt field, a text field, a search filed, etc.). The inputs 115 may include topics of interest, requests for data, prompts for AI (including user requests for particular tones/emotional qualities, style, lengths, outlines for each of at least one of several parts requested for the AI/ML model 146 response and the like) rules for accessing and/or generating requested content, etc.

The language 117 may be an input including a preferred language of content outputted in response to the inputs 115. In some embodiments, the language 117 may be entered with the input(s) 115 in the same field. In some embodiments, the language 117 may be entered in separately from the input(s) 115 in the same field. In some embodiments, the language 117 may be entered in a subsequent session of application 106. In some embodiments, the language 117 may be entered to modify the current language in which the application 106 is configured to teach to view particular content in two or more languages at the request of the user.

In operation of learning environment 100, a user may download and open the application 106 on user device 102. A processor associated with the user device 102 may communicate with the cloud server 104 or other storage space or database to download up-to-date data 118 as updates 116, which may be stored both on cloud server 104 and locally on the user device 102. In some embodiments, user data 114 may be shared between and stored on one or both of user device 102 and cloud server 104. Storing such data 114 on cloud server 104 may enable the user to access the data 114 on any device configured to access cloud server 104 with permission to access user data 114, for example.

FIG. 1B is a block diagram illustrating an example framework of the learning environment 100 described herein. The environment 100 may include the user device 102 executing an application 106 that presents content to the user in the learning environment. In some embodiments, the application 106 represents the learning environment. The environment 100 may be in communication with server 104 to exchange user data 114 and/or receives common data 118.

The application 106 may be native to the user device 102 and may be part of an operating system of device 102. The application 106 may be an app or application downloaded and/or otherwise stored on a hardware component or downloaded and/or stored on the computing device 102 that is communicatively coupled to the hardware component (e.g., processor 172, memory 174, etc.). The application 106 may process, execute, display, generate, and otherwise analyze speech data, image data, audio data, language data, etc. In some embodiments, the application 106 may generate data (e.g., content) pertaining to any of the data described herein in a form for display to a user of user device 102. For example, the application 106 may include or otherwise utilize UI generator 134 to generate user interfaces and corresponding user interface content (e.g., menus, controls, flash cards, flash card editors, flash card review interfaces, text displayers, audio players, video players, text input fields, voice editors, tables, lists of data, web pages, loading screens, libraries, error message screens) for display to a user on device 102, for example.

As shown in FIG. 1B, the application 106 includes or has access to an AI content generator 130. The AI content generator 130 may be utilized by other portions of application 106 to analyze data and generate content as described in further detail elsewhere herein. The application 106 further includes a study materials generator 132, a user interface (UI) generator 134, an interactive reader module 136, tools 138, a cache of saved content 140, and a language repository 142 including data for words and/or phrases and their properties, including, but not limited to frequency of use, grammatical gender for each of one or more languages.

The language repository 142 may represent a repository of language data for collections of words and phrases associated with the language. The repository 142 may be generated using the AI model (e.g., AI/ML model 146) and may include data indicating a frequency of use of one or more word or phrase in the collections of words and phrases, data indicating a determined difficulty for one or more of the collections of words and phrases, definition data for one or more of the collections of words and phrases, and data indicating related topics to one or more of the collections of words and phrases.

The AI content generator 130 may generate content for display in the application 106 in response to receiving a request from a user of device 102. For example, the AI content generator 130 may receive user input and add further instructions to the input to create a prompt which is given to a bot (e.g., a chatbot) by an Application Programming Interface (API) call, for example, or to locally installed or remote accessible AI/ML model(s) 146. The output from the AI/ML model 146, for example, may be passed to an interface created by the UI generator 134 allowing the user to view the content on demand, or in some embodiments automatically.

In some embodiments of the application 106, there is a UI element within a lesson menu where the user can input a requested topic. In response, the AI content generator 130 then creates a prompt for the AI/ML model 146 on the topic specified by the user. The prompt may be used by the user to trigger a request for content that may be limited in difficulty to align with the level of the lesson and that provides many examples of concepts that are taught in the lesson. For example, if the user is learning about how the conditional tense in Spanish is used in some embodiments, the user may be able to enter within a text input UI element a request to read about “the migratory patterns of birds.” In some embodiments, the processor 172 would then add on to the user request in one embodiment “Please write something for me in Spanish which includes lots of examples of the Conditional Tense. Please avoid using more advanced grammar, specifically avoid the subjunctive mood and limit your word choice and overall complexity to that of an 4th grade reading level or below. Write between 500 and 1500 words. Please write about: the migratory patterns of birds.” With this guidance the AI content generator 130 generates content on the topic the user is interested in and which includes many examples of the Conditional Tense so the user can see how it works in practice without the obstacles of more advanced grammar, rare words, or highly complex syntax. In some embodiments, the system 100 also presents a UI element not related to any particular lesson where the user can add a prompt which will be sent to the AI content generator 130 with some, all, or none of the other additional instructions appended requesting a certain length, difficulty, topic, and the like. The user is free to request content on any topic with any modifications or specifications they may wish, though restrictions may be put in place as to length of response, subject matter, vocabulary and the like. For example, the user may request a story about a business negotiation which demonstrates a wide range of words and phrases commonly used in the workplace and in the context of sales and finance. The user input 115 is modified by the application to ensure the output is in the target language, possibly along with other modifications, and is passed to AI content generator 130 which produces the requested content. This content is then displayed to the user in the interactive reader module 136. The content is analyzed by the application and supplemental views are generated 134 where the user can take advantage of supplemental study materials 132 to focus on the words and grammar present in the story. The user can also read the story later by accessing it in the saved content repository 140. In some embodiments, the system 100 may access a library of pre-written prompts for the AI content generator 130 that request content on various topics in various tones, styles, and levels of difficulty which the user can choose from and modify. The study materials generator 132 is a series of tools used to provide helpful information and study tools 138 to the user in real time through the application 106. One example study tool may include a flash card review tool. The flash card review tool may be part of tools 138 that may utilize study materials generator 132 to generate digital flash cards. The digital flash cards may be viewed or otherwise accessed in a review session within the application 106. The digital flash cards seen during a review session may be limited to align with the words used in a certain instance or instances of content, by some category or categories such as words related to emotions, by rarity, by difficulty, etc. In this embodiment, the application 106 (e.g., executing on processor 172) may determine a user assessment using user assessment engine 144, for example, and may then determine which tools 138 to utilize. The user assessment engine 144 may assess a user's learning level, learning performance, memory performance or memory likelihood, or other performance based assessment to determine which cards to display to the user in application 106. For example, the user assessment engine 144 may assess memory retention of the user based on content recall of particular cards. In some embodiments, the user assessment engine 144 may assess the time since the user last saw particular cards and use such an assessment to generate a modified flash card deck for the user to continue learning.

The tools 138 may also include tables showing the various forms of words, such as the conjugations of verbs in Spanish in one embodiment, dynamic explanations of various aspects of grammar and/or culture. For example, while reading content the user may choose a verb in the story and see both a dynamic table where all the conjugations of that verb can be accessed in real time and a dynamic explanation for how to form all of those conjugations for that verb. Each tool 138 may prepare content in an asynchronous manner in the background, for example, automatically, or alternatively, when the user selects a word.

The user interface (UI) generator 134 may generate user interfaces for application 106. The UI generator 134 can connect various views to one another through navigation links and programmatic functions which may automatically change the interface(s) as operations occur in the background. In some embodiments, a design pattern is a set of files defining all the visual elements and the associated logic and stylistic features for displaying UIs may be used with tools 138 and/or models 146 elsewhere in the application 106 to execute computationally intensive operations such as generating the tools, generating and analyzing content, and reading, writing, and passing data locally and with the cloud database.

The interactive reader module 136 hosts and presents content. For example, the interactive reader module 136 may display text and may display and/or otherwise execute an audio player and/or a video player. The interactive reader module 136 may also display text while analyzing the text in the background asynchronously by reading the words and phrases of the content and matching any findings with the corresponding data in the language repository 142 to retrieve meanings, including using the surrounding context to narrow down the options between homographs. A non-limiting example of narrowing options between homographs may include detecting subjunctive usage. In particular, in Spanish, the subjunctive generally cannot occur unless a triggering word or phrase has already appeared in the sentence; when a word comes up that is a homograph of an imperative form (e.g., for commands) and the subjunctive form of a verb and no triggering word or phrase has appeared in the sentence, the interactive reader module 136 may be limited to presenting information related to the imperative form.

In some embodiments, the interactive reader module 136 displays this data for words and/or phrases dynamically by user selection, using an automatic progression, or a combination thereof. The module 136 may read data which reflects, for a specific user, a determined confidence with the words, phrases, and/or grammar in the target language to color selected words based on that level of determined confidence. The interactive reader module 136 also provides links to the study materials 132 including passing all the words, or some selected word, phrase, or the like to a study tool that is prepared in real time to assist the user. The interactive reader module 136 may also include interactive text-to-speech (TTS) with voices in several accents with variable pitch speed, and the like. The dynamic display of information and selection of words and/or phrases may be coordinated with the TTS. For example, the user may be reading content and tap on an instance of a Spanish verb. The TTS tool 138 may then be used to read that word out loud, the reader may present the meaning, lemma, and conjugation of the verb in that instance using data from the language repository 142. That verb may also, if the user's level of confidence is determined to be high, be highlighted in green. A control for navigating to a view where the user can read an explanation as to how to form the conjugation that instance of the verb is in from the lemma may also be available to the user.

The tools 138 may include settings adjusters for the interface and modules of the application, links to online translators and dictionaries, websites, APIs, an audio player and/or a video player. Some or all of these tools may be integrated within various instances of the interactive reader module 136 within the application 106, but may also be accessible through the interface alongside or in interaction with study materials (generated by study materials generator 132) and all forms of AI generated content (generated by AI content generator 130). The tools 138 may also include an editor for the TTS voices, allowing the user to change parameters such as the speed the voice reads at, its pitch, accent, and the like. The tools 138 may further include the ability to change the size of the text, stylistic elements of the app, and the like.

The saved content 140 may be a local cache of previously created content including from the common data 118 sent from cloud databases/server(s) 104, data previously created by the user which is either created by the AI content generator 130 and saved directly there or downloaded from the cloud databases/server(s) 114 and saved and/or used or executed upon locally. In some embodiments, the user may be able to paste, download, or otherwise save other forms of content here. Larger forms of common data such as books, audiobooks, video and the like may also be saved so they can be accessed by the user later even without an internet connection. These and other forms of content also may be created by the AI content generator 130 or copied from the cloud to the local device and be saved, downloaded, or otherwise used.

Base forms of words, and in some cases all the forms of words, may be downloaded from the cloud (e.g., servers 104) or may instead be part of the language repository 142 and/or may be otherwise stored in memory 174. The application 106 may also generate additional forms of words in the target language from these base forms or all forms may be downloaded and stored to be available within the application 106. The language repository 142 of data for words, phrases, and other language data including information which classifies their frequency of use and which categories they are in may be stored locally for rapid comparison to all text in any viewed content to pass the relevant data for the analyzed content to the study materials, interactive reader, and other tools asynchronously in the background and/or synchronously, and/or in some combination thereof while the user is interacting with one or more of the tools 138.

In some embodiments, the cloud databases/servers 104 represent a database server, an application server, an internet server, a cloud server, or other remote server or device capable of storing, receiving, and sending data to user devices (e.g., user device 102). In some embodiments, the servers 104 may store user data 114, common data 118, user profile data, historical user data, historical community data, algorithms, machine learning models 146 and AI functionality, language data, software updates, or other data. With appropriately configured user permissions, the servers 104 may share this data with the user device 102, and the servers 104 may receive newly acquired user data 114 from the user device 102.

The user device 102 includes a communication module 170 to enable communications with one or more servers 104 and/or other computing devices. The communication module 170 may include components and software that may enable device 102 to communicate with one or more servers 104 or other computing devices directly or through a network (not shown). For example, the communication module 170 may include antenna circuitry (e.g., one or more antennas or coils) for wireless connections including, but not limited to Bluetooth, Wi-Fi, radio frequency (RF), or other near field communication protocol. In some implementations, the communication module 170 may also enable cellular data service for the user device 102. The communication module 170 may also include components for wired connection, such as USB data transfer.

The user device 102 also includes one or more processors 172 coupled to memory 174. The one or more processors 172 may include one or more hardware processors, including microcontrollers, digital signal processors, application specific integrated circuit (ASIC), a field programmable gate array (FPGA) or other programmable logic devices, discrete gate or transistor logic, discrete hardware components, or any combination thereof designed to perform the functions described herein and/or capable of executing instructions, such as instructions stored by the memory 174. The processor 172 may also execute instructions for performing communications between the user device 102 and the servers 104 or other computing device.

The memory 174 may include one or more non-transitory computer-readable storage media. The memory 174 may store instructions and data that are usable in combination with processors 172 to execute processes described herein. The memory 174 may also function to store or have access to saved content 140 and language repository 142 including, for example word and phrase data.

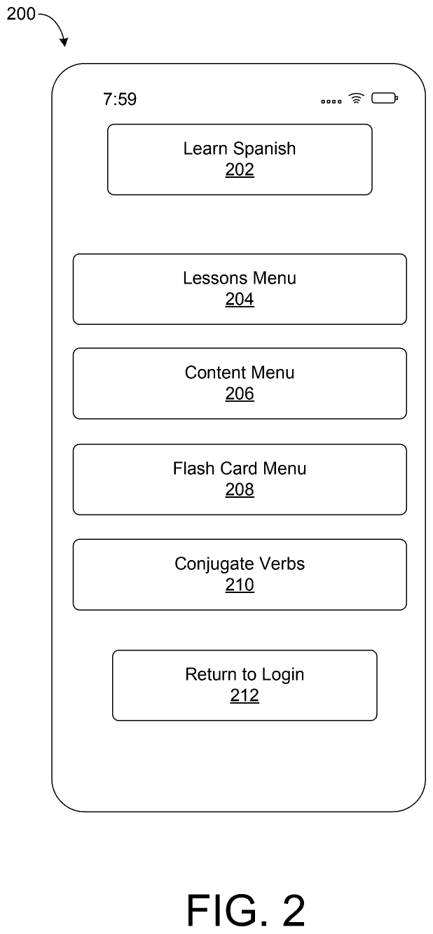

FIG. 2 is an example screenshot 200 of an embodiment of a main menu available in application 106 where the current target language is specified in the title 202. In some embodiments, the application 106 may have a menu giving access to features such as Lessons 204, a Content Menu 206 for generating new content, viewing pre-made content, revisiting previously generated content and the like. There may also be access to study tools such as flash cards 208, conjugation tables 210, and other study tools that may be generated by study materials generator 132. The application also includes a return to login control 212 to allow the user to return to a login screen of the application 106. In operation, a user may select any of the controls 202-212 to interact with the application 106, as described in detail elsewhere herein.

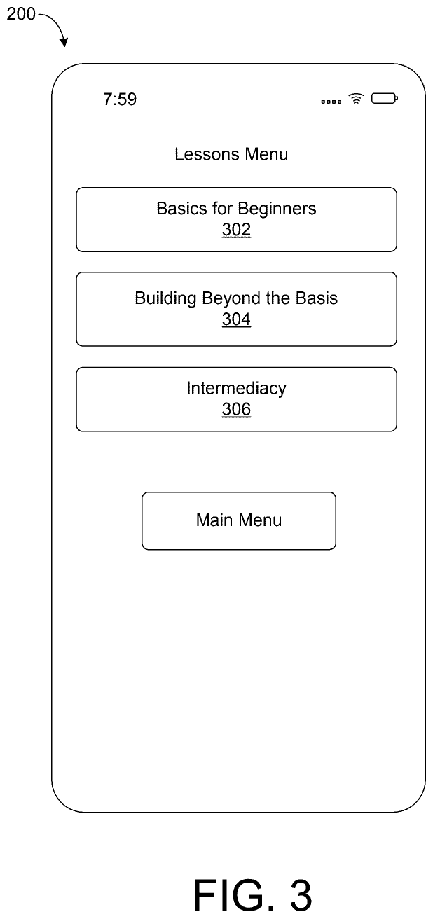

FIG. 3 is an example screenshot 300 of an embodiment of a top level menu for lessons. A user may have selected lessons menu 204, for example to be presented with the content associated with screenshot 300. In this embodiment, the lessons are grouped into three levels of difficulty: basics for beginners (e.g., control 302), building beyond the basics (e.g., control 304), and intermediacy (e.g., control 306). While three levels of difficulty are depicted, one skilled in the art will appreciate that any number of difficulty levels may be included in a lessons menu. For example, if the target language is Spanish, selection on the basics for beginners control 302 may teach the user individual words and rely heavily on translations and the language through which Spanish is taught to explain basic grammar and vocabulary. Similarly, selecting on the beyond the basics control 304 may cover topics typically covered in more advanced courses such as the subjunctive mood and conditional tense. It may feature sentences and entire paragraphs of content in the target language and focus on building up the user's vocabulary to the point that they can read simple content in Spanish without having to look up most of the words. Further, selection on the intermediacy control 306 may provide the user content to focus on expanding vocabulary and learning about precision and subtle differentiation in context, as well as more advanced grammar and cultural topics. This may provide content suitable for a user that understands the essential grammar of the target language (Spanish in this example). In some embodiments a study schedule for which lessons to view and review may be suggested to the user by the application's algorithm.

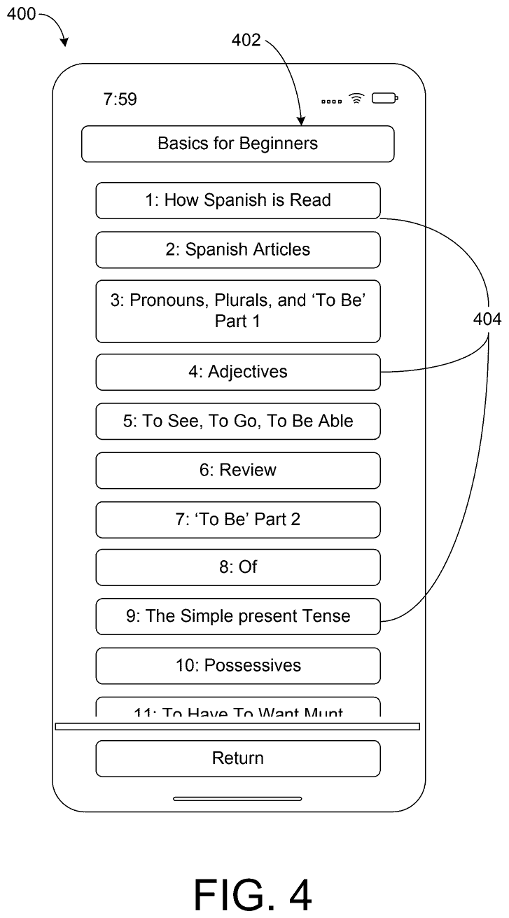

FIG. 4 is an example screenshot 400 of an embodiment of an example submenu for lessons. In this embodiment there is a title relating to one of the menu options for some level of difficulty, in this case basics for beginners 402, which correlates to prior user selection on control 302 (FIG. 3). The submenu of screenshot 400 includes a menu of lessons focused on various topics 404.

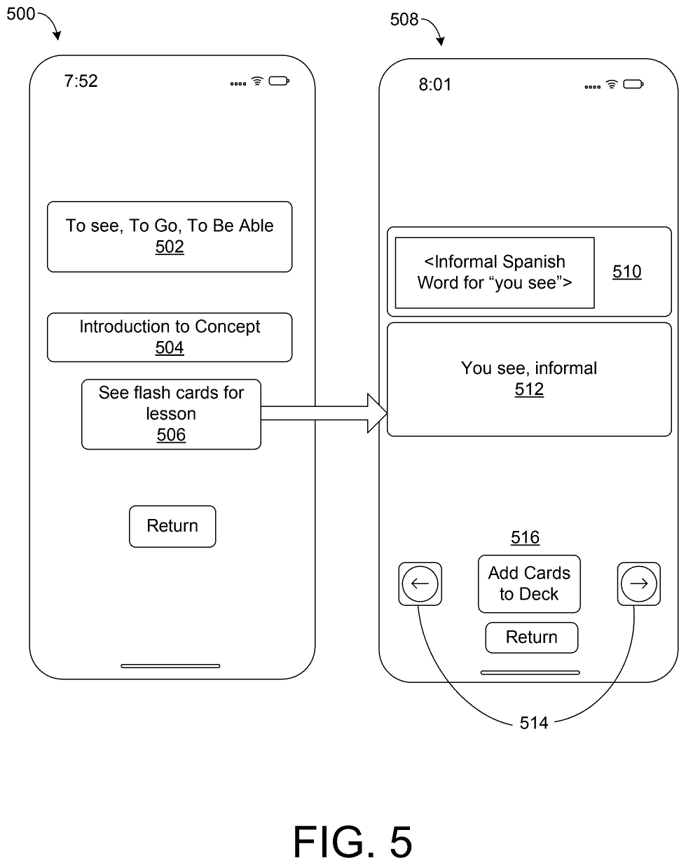

FIG. 5 is a set of example screenshots of an embodiment of a menu 500 for a lesson on a particular topic. In this embodiment there is a title 502, a control to navigate to a view where the content of the lesson itself 504 can be viewed in the interactive reader module 136 and a control to see predefined flash cards (e.g., front side 510, back side 512) for reviewing some or all of the content of the lesson 506. The flash cards may be individually displayed in screenshot 508 with the front side 510 and the back side 512. The cards may be viewed one at a time and browsed through by controls 514. The user may have the option to add individual cards to the deck or all of them at once as shown by control 516.

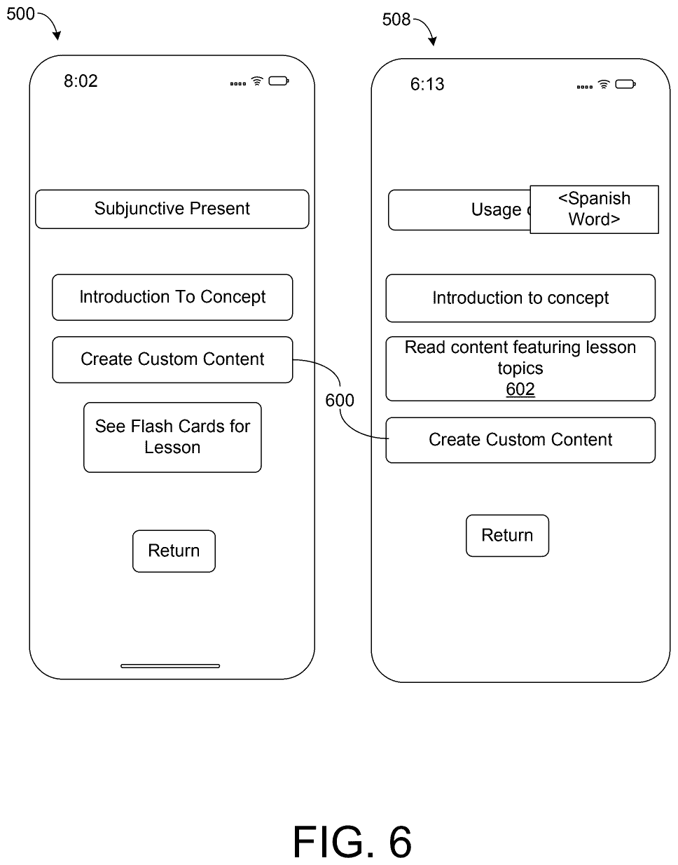

FIG. 6 depicts example screenshots 600 of an embodiment of menus for lessons which feature controls for interacting with and generating content. In this example the AI content generator 130 can be accessed to create content 600 which can be viewed in the interactive reader module 136. The user can use tools 138 to help them understand the content and access controls to see views with study materials relating to the content 132 with interfaces generated by the UI generator 134. Content previously created, if it exists, which has been made to give examples or discuss the lesson topic(s) stored on the device 140 or in a cloud database 104 may also be accessible by selecting a control 602 to read the content featuring the lesson topics.

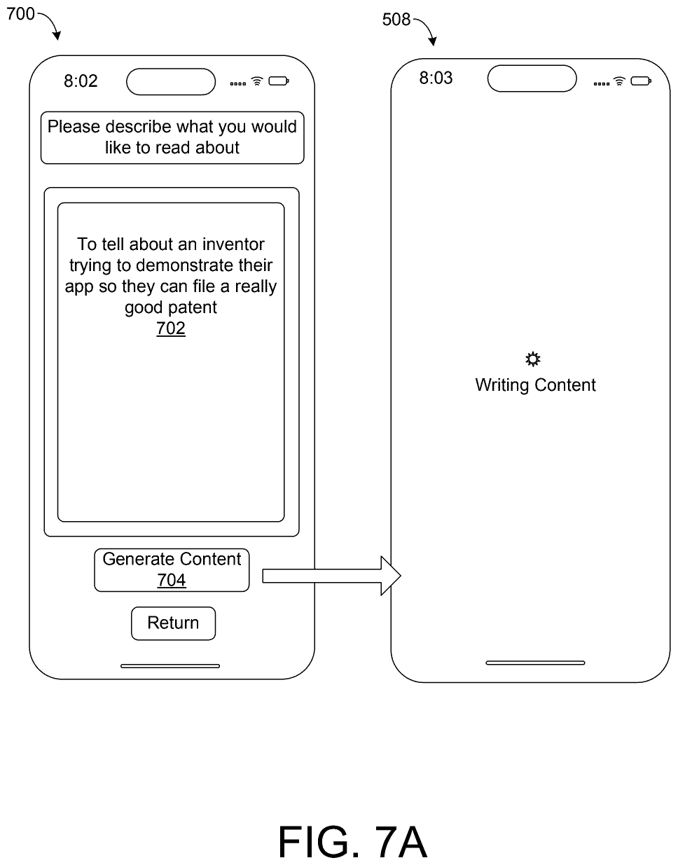

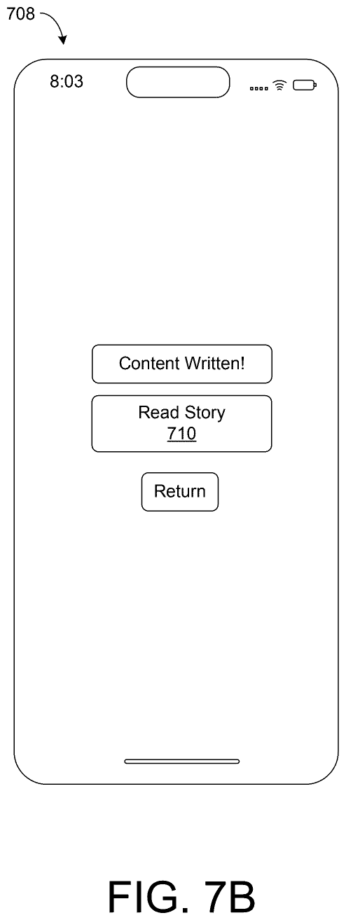

FIG. 7A is an example screenshot of a text input field interface 700 for telling the application 106 the topic about which the user wants content. The user enters a topic which they would like to read about, along with any further instructions which will be passed to the AI content generator 130 that the user may want to include in the input field 702 and indicates to create the content by selecting a control e.g. 704. In some embodiments this control takes the user to a loading screen 706 while the AI content generator 130 creates the content using the AI model 146, for example. In some embodiments, this topic input interface may be accessible in the context of a lesson, and depending on where it is accessed the application 106 appends instructions to the user prompt to ensure the content is tailored to the context (e.g., in a lesson as an example) and the determined level of the user. There may also be tools for suggesting topics to the user. The application 106 (and/or AI content generator 130) may use AI/ML models 146, for example, to generate content for the user according to user requests, according to a language learning level, and/or according to the parameters programmed into the application 106 to ensure that the content is of an appropriate length, tone, difficulty, and otherwise curated to maximize the user's enjoyment and learning. For example, the user may open this view and write that they would like to read content focused on the history of building bridges. This prompt may have additional instructions added to it indicating that the content should be at least 500 words in length, be at a 6th grade reading level, and written in a casual tone. The AI content generator 130 then creates content in response to this prompt. The user can then read this content in the interactive reader module 136 where it is analyzed in real time. The user can access study materials 132, complementary views generated by the device 134 and the like. Based on the user's interactions with the content and study materials 138 the user's abilities are assessed by the assessment engine 144. In some examples, the user may, from within the menu for a particular lesson request content in which it is also appended to the prompt that the content should contain examples of the new vocabulary, grammar, and the like that are discussed in the lesson.

In operation, the user inputs what they would like to read about, and possibly other instructions, and the processor may add additional instructions based on the context, such as within a lesson, as previously described. In some embodiments, retrieval augmented generation (RAG) may be used to improve the quality of the AI model output by feeding the model 146 an example story and/or more verbose instructions for creating quality content tailored to a specific level.

In some embodiments, custom difficulty parameters may be created to ensure that the AI changes how often it includes any other words, phrases, and/or grammar based on a determined level of difficulty to which the produced content should correspond. In some embodiments, custom embeddings, fine-tuned models, and other AI model enhancement tools may be used. The request and receipt of content by AI may be accomplished by an API call to a third party AI service, an API call to an AI service created specifically for the learning environment described herein, and/or an AI service installed locally on the device, possibly within the learning environment itself. In some embodiments, the resulting response returned from this API call once reformatted (if necessary) into a string, for example, may then be split up into a number of pages so that a reasonable number of characters are displayed on each page based on the font size the user or environment has configured. In some embodiments, these settings may be modifiable by the user. In some embodiments, once the content is created it can be read in an interactive reader module 136 and saved in a local 140 and/or cloud database 104 for later access.

FIG. 7B is an example screenshot 708 of a view that is shown once the AI generator has created the requested content. The user may proceed to interacting with the content by a control such as 710.

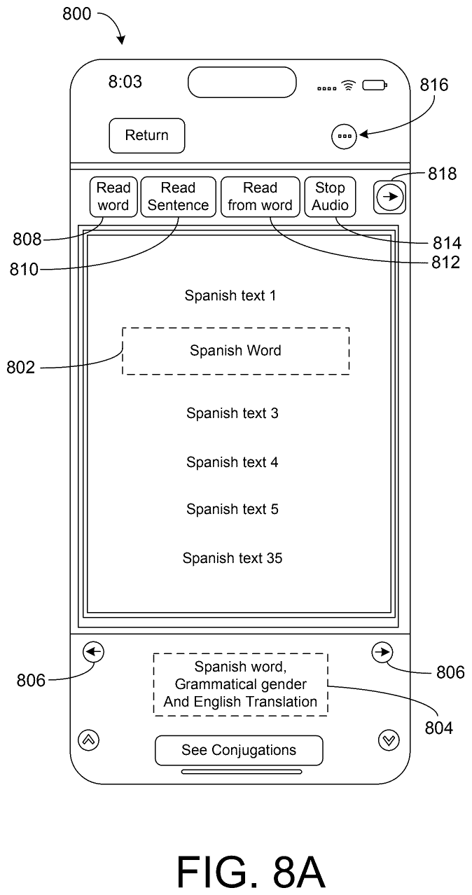

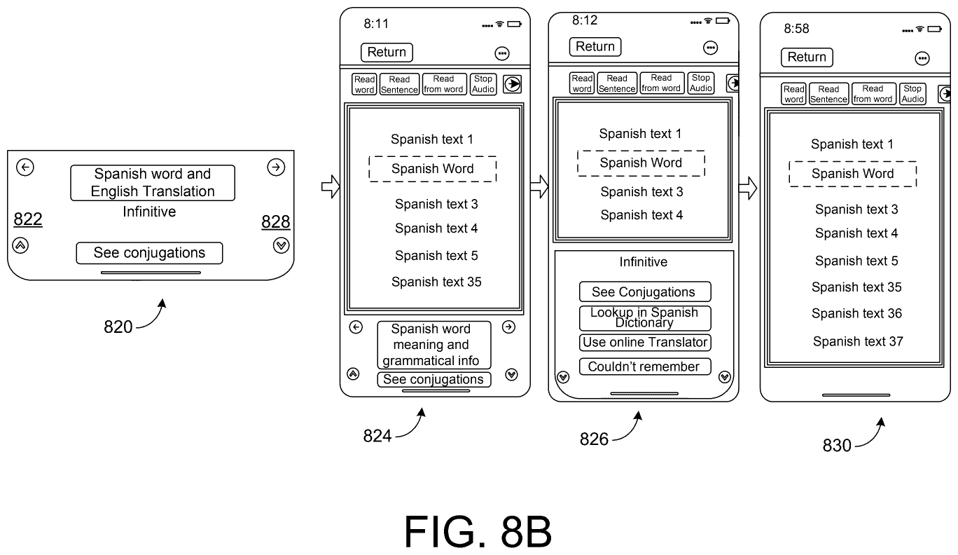

FIG. 8A is an example screenshot 800 of an interactive reader module 136. In some embodiments, there may be text displayed from a lesson 800, from content from the AI content generator 130 previously generated content stored on device 140 or in a cloud database 104, text pasted in or downloaded by the user or from the internet. In this embodiment, the text is displayed in a scrollable view so it can be navigated with a swipe of the finger (or other input depending on the platform/device). Words can be selected by the user and may be manually or automatically progressed through. In this embodiment, a selected word 802 is shown. When words and/or phrases are selected, they may become highlighted with a certain color (or otherwise marked or modified) to indicate the determined user confidence of the word. When a word is selected, information about the word including its morphological lemma, English translation, conjugation, and the like are retrieved from the language repository 142 and displayed 804. The word or phrase the additional information for which is shown here can be rapidly changed to that of a neighboring word or phrases using the controls 806. In this embodiment, the TTS tool can be setup to automatically read selected words, phrases and the like out loud, and there may also be controls to read just the selected word 808, the whole sentence the word is in 810, all of the content on the page. There may also be a means of reading aloud a sequence chosen by the user or even everything on the page from the current word or phrase onwards 812. The audio may be stopped manually at any time 814 and may also automatically be stopped under certain conditions. If the TTS is in the process of reading a sentence or other portion of text larger than a single word or phrase, the user can still select parts of the content to see the information on the selected content without interrupting the TTS. For example the user may use a control so that the TTS module begins reading an entire sentence, and while the sentence is being read out loud the user may tap on individual words and phrases and see information about them while the TTS module continues to read the sentence uninterrupted. Other ways of rapidly reading selected portions of the text or reading the same word, portion of the text, etc. at various speeds, pitches, accents and the like may also be incorporated using a control 816. In some embodiments, various controls may be available for browsing through pages or other portions of content. Example controls may include one or more page flip controls 818.

FIG. 8B depicts example screenshots of an embodiment for how tools are incorporated and the study material generator's data interacted with within the interactive reader module. In one embodiment, within the interactive reader module's scrollable information view 820 there is a control for stretching and contracting the size of the view 822. The contracted view 824 covers less of the content than the stretched view 826. In both cases the user can scroll through the view to see all its contents dynamically. In this embodiment, there is also a control for toggling (e.g., hiding) the view 828. View 830 shows an example of when the interactive reader module's information view hidden in this embodiment, allowing more of the content to be shown.

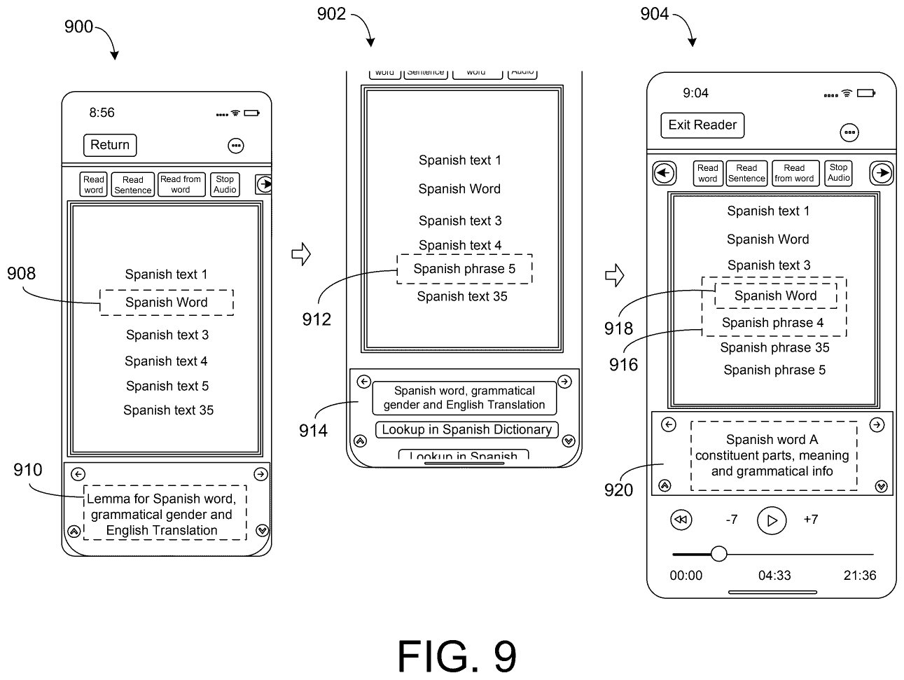

FIG. 9 depicts example screenshots 900, 902, and 904 of further examples of the kind of data that may be displayed in the interactive reader information scrollable view in some embodiments. Screenshot 900 is an embodiment showing the lemma, conjugation details, and a translation for part of the content (e.g., Spanish word), which is indicated by a dotted line 908. This data is retrieved from the language repository 142 and displayed in the interactive reader module 136. The indicated word is also provided in block 910 with a definition of the word. Screenshot 902 is an embodiment showing the lemma, meaning, and grammatical gender for a noun (e.g., Spanish text 5), which is indicated by a dotted line 912. The indicated word is also provided in block 914 with a definition of the word. Screenshot 904 is an embodiment of the interactive reader module 136 working in combination with an audio player in which the text (e.g., Spanish phrase 4) corresponding to the text that would be read at the current audio timestamp is highlighted in a dotted line 916. The “Spanish word A” is also highlighted by another dotted line 918 with a definition of the word provided in block 920. In general, the word(s) and/or phrase(s) that a reader has selected is highlighted/indicated in a way that is differentiable. In this embodiment, the Spanish word may be a combination of two composite words, which is indicated in the interactive reader information interface element. While the indicators shown here are dotted lines, any indicator can be applied including, but not limited to arrows, bouncing cursors or other objects near next and moving across the text, text color change, font style change, text size change, or other UI change, or any combination therein.

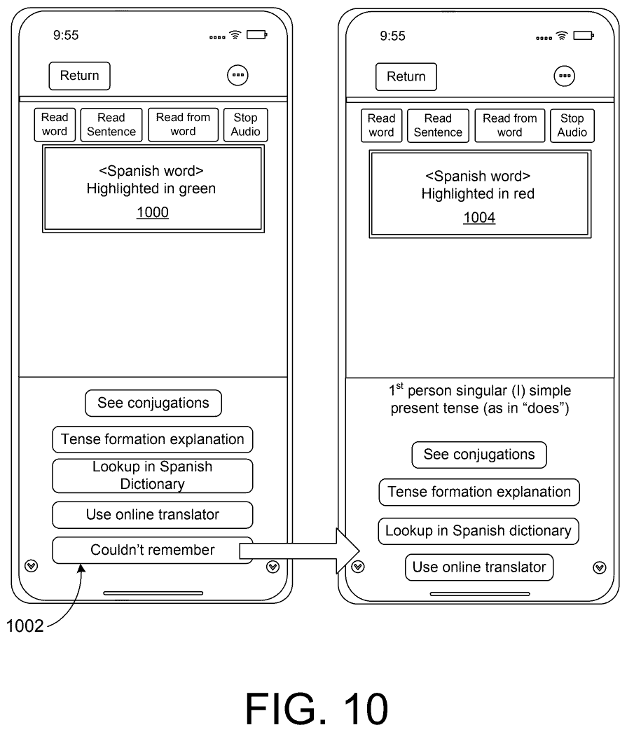

FIG. 10 is an example screenshot of an embodiment of the interactive reader module interacting with study tools 132 generated by the application 106. In this embodiment, there is a control in the interactive reader information view that appears when the selected word, phrase, or the like 1000 is determined to be well known by the user. In this embodiment, the user can tap, click or otherwise select upon the control which may indicate “Couldn't Remember” 1002 which indicates to the environment 100 that the selected item is not well known (and/or not well understood) by the user. From that point on when instances of the word, phrase, or the like are selected the interactive reader module indicates that the word is determined to be difficult for the user. Such an indication is shown by highlighting the word in red 1004 until the determined level of confidence for that user is updated again. For example, the user may tap on a Spanish word which is highlighted in green to show that they indicated a high level of confidence last time they saw it. Supposing, however, that the user now struggles to remember its meaning and uses the “Couldn't Remember” control to indicate that this is now the case. The study tools generated by the study materials generator 132 will now focus more on this word until it is determined to be well known by the user again. In some embodiments this may also be done with phrases, aspects of grammar, and the like.

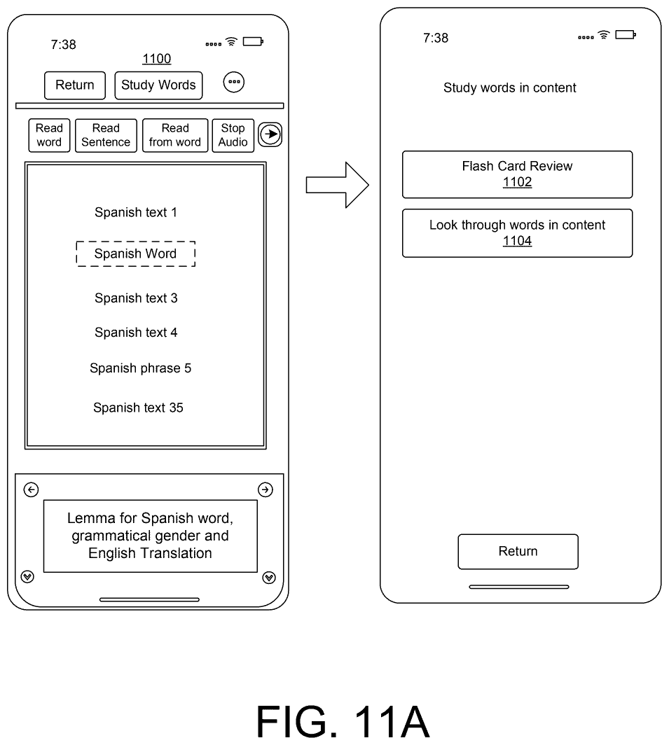

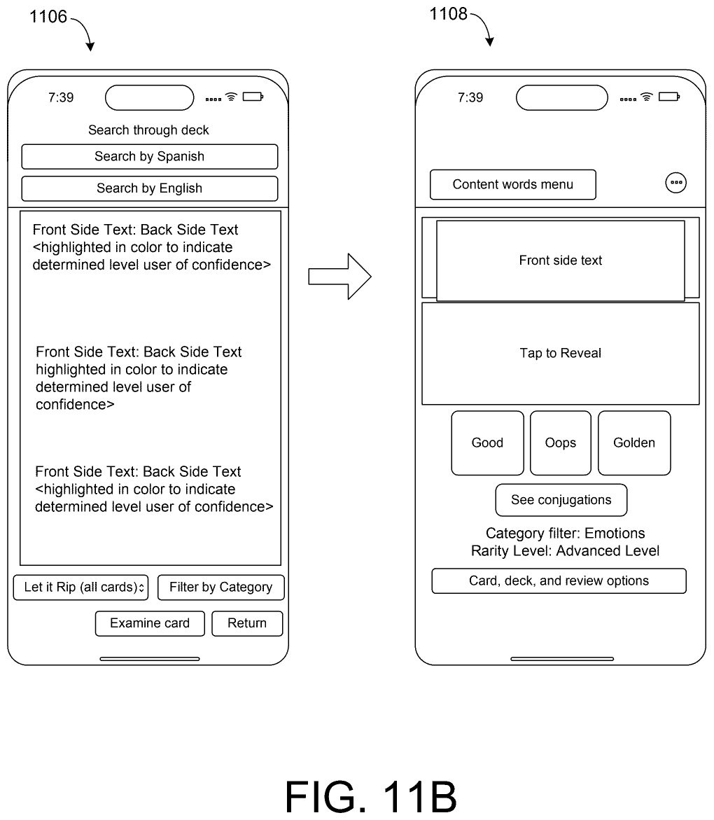

FIG. 11A depicts example screenshots of one embodiment of an integration of a flash card study tool into the interactive reader module. In this embodiment, there exists a control 1100 which, once the text on the page is analyzed, allows the user to use a flash card review module 1102 and examine the words used in the story 1104. Within the interactive reader module 136 the data from the language repository 142 is used to try to identify all of the words and phrases used in the story. All those that are identified are used to fetch the corresponding flash cards from memory 174 and/or create new flash cards for the user. The study materials generator 132 prepares them for use in a flash card view generated by the UI generator 134 which the user can use to focus on the words and phrases identified in the particular content. In some embodiments this tool may use data resulting from analysis in the scope of the whole of the content, or some other portion besides a page, or in the scope of multiple instances of content. In some embodiments other study tools 138 may also be integrated which use this data.

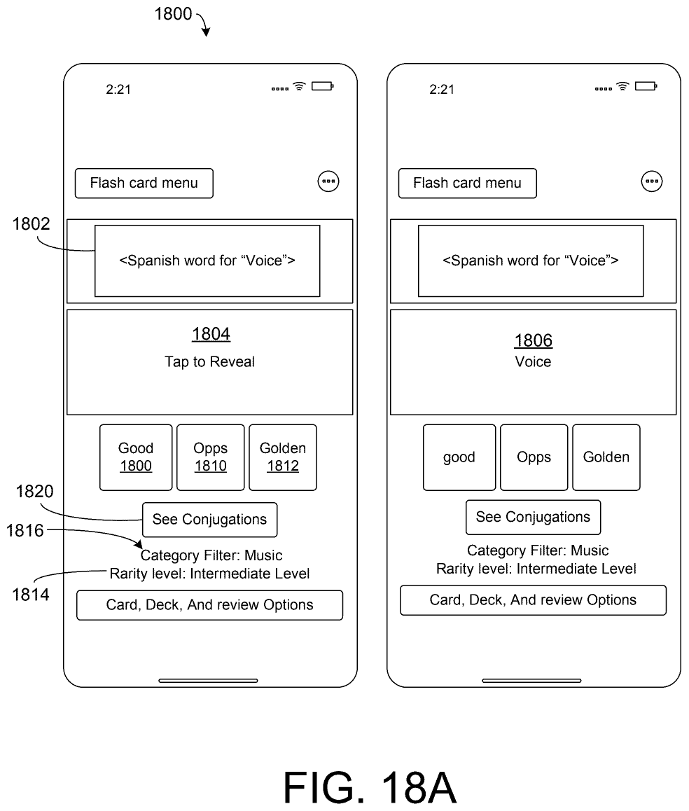

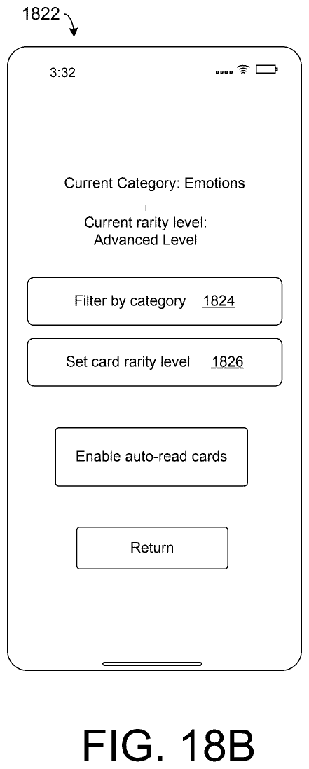

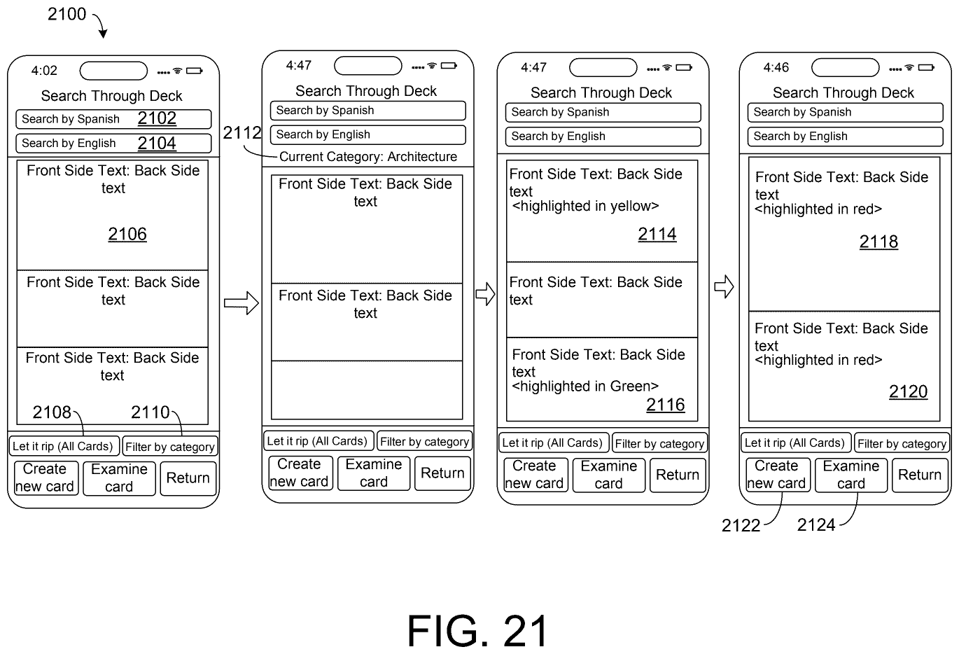

FIG. 11B depicts example screenshots of embodiments of use of a flash card study tool 138 generated within the application 132 that is integrated into an interactive reader module 136. This includes looking through the cards 1106 corresponding to data selected in consequence of the analysis of content, in this embodiment, including all the features detailed by FIG. 21 and its accompanying description except for the ability to create a new card. In this embodiment, the only cards shown are those which are present in some form in the content presently in the interactive reader module. There also may be a flash card review feature 1108 detailed by FIG. 18A and its accompanying description, in some embodiments limited to the same cards shown in the list interface 1106.

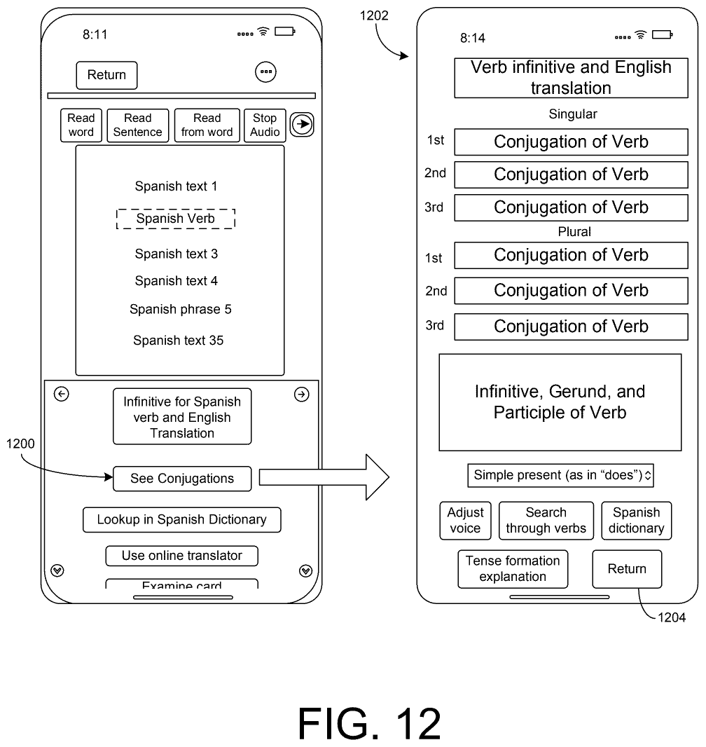

FIG. 12 depicts example screenshots of an embodiment of one of the study materials generated by the study materials generator 132 in this instance a conjugation table, which is integrated into the interactive reader module. In this embodiment, the user can click “See Conjugations” 1200 to see the verb in its various forms in a conjugation table view 1202 and quickly jump back when they are done with another control 1204. These forms are stored on the device 142 and/or generated by the processor 172.

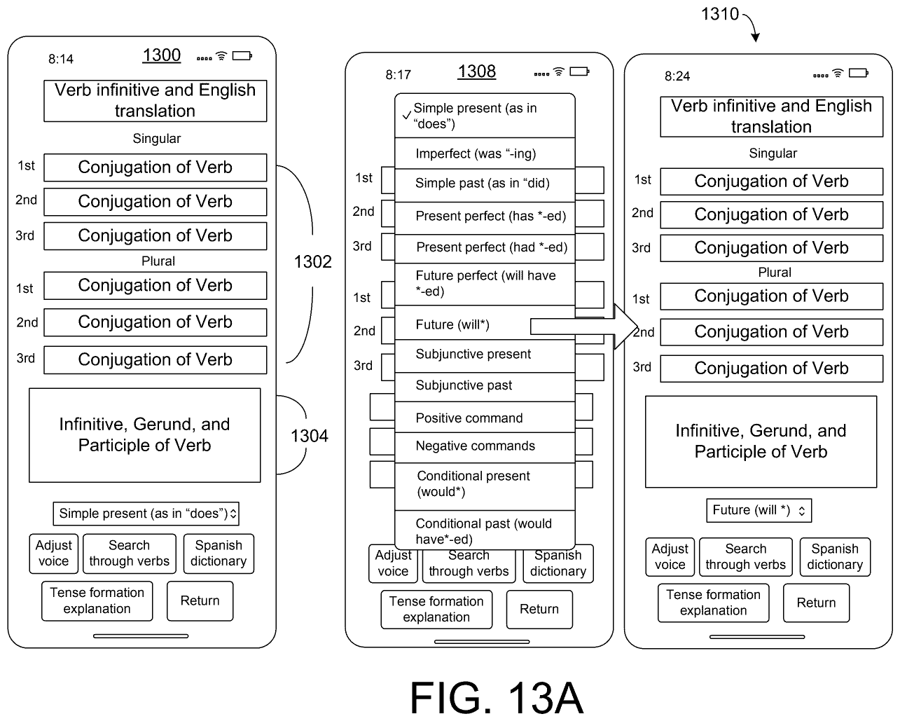

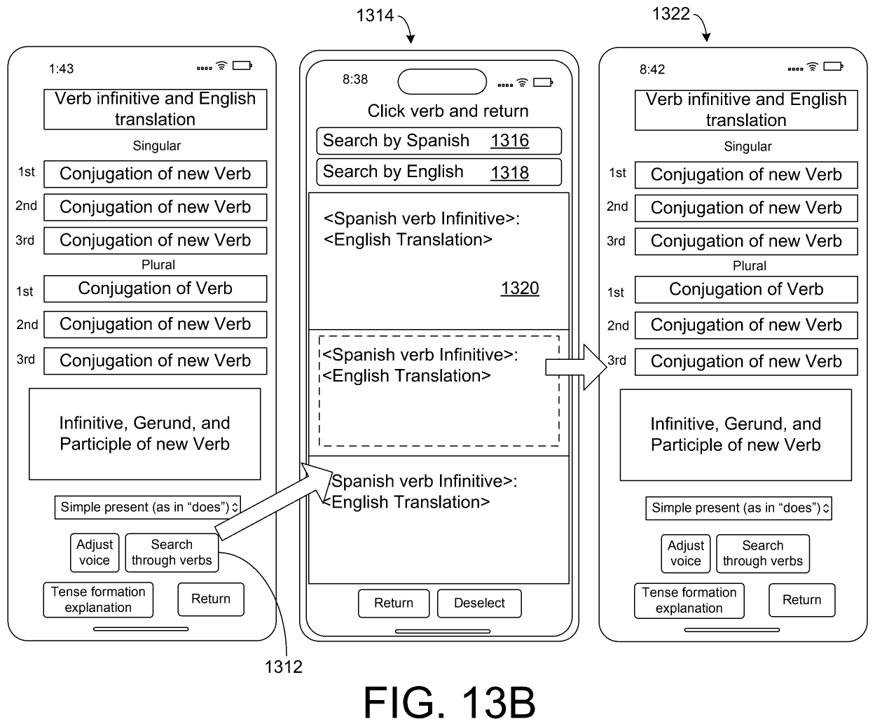

FIG. 13A depicts example screenshots of an embodiment of a conjugation table study tool. In this embodiment, data is pulled from the language repository 142 and presented in a view created by the UI generator 134 that displays a translation 1300, the various forms in the given tense and mood 1302, other forms that may be important to continually display 1304, and a picker for changing the forms shown 1306. In this embodiment, when this picker is selected a menu pops up allowing the user to pick a set of forms 1308 which the study tools generator 132 immediately creates and passes to the conjugation table for the user to view 1310.

FIG. 13B depicts example screenshots of an embodiment of an interface enabling dynamic reusability of a study tool, in this case a conjugation table, in coordination with the language database. In this embodiment, a control 1312 opens a view 1314 where the user can browse, scroll, or otherwise interact through verbs in the language repository 142, including searching by target language 1316 and the language they are learning through 1318. The user can select any verb in the database 1320. When the user selects on a verb, the study materials generator 132 automatically creates the forms in real time so when the user returns to the conjugation table it is displaying the forms for that verb 1322. In some embodiments, similar tools 138 for various forms of declensions of nouns, adjectives, articles, phrases and the like may be included in the application depending on the target language(s).

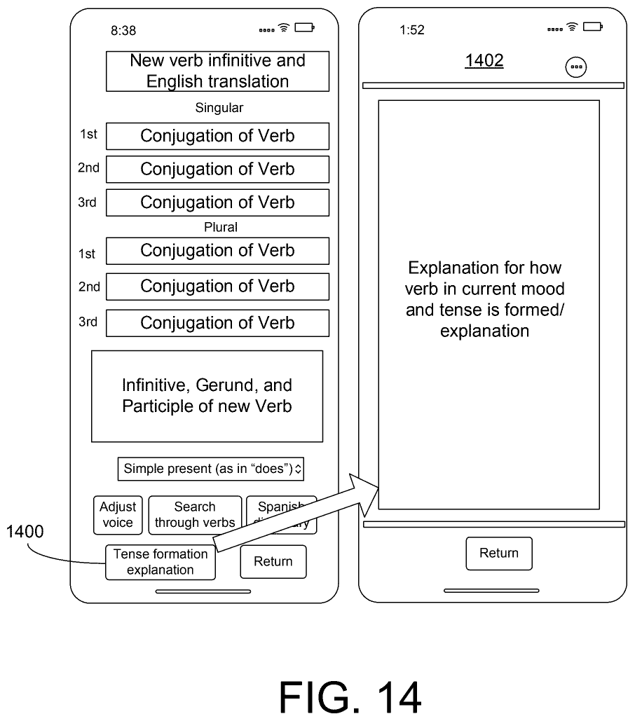

FIG. 14 depicts example screenshots of an embodiment of a dynamic study tool, in this case a tense formation explanation generator. In this embodiment, the user can use a control 1400 in the conjugation table UI, but in some embodiments this may also be available in the interactive reader module 136 information view and/or elsewhere within the application. In this embodiment, the user clicks, taps, or otherwise selects upon a control to open a scrollable text view which shows an explanation that has been created to explain how the specific shown forms for the specific verb are created in a way that relates to broader patterns within the language 1402. In some embodiments the study materials generator 132 can interpret the language data pulled from the repository 142 and/or generated by the processor 172 and write an explanation explaining in what ways the forms for a particular verb may differ from broader patterns and why which is then presented in a view generated for the user by the application 134.

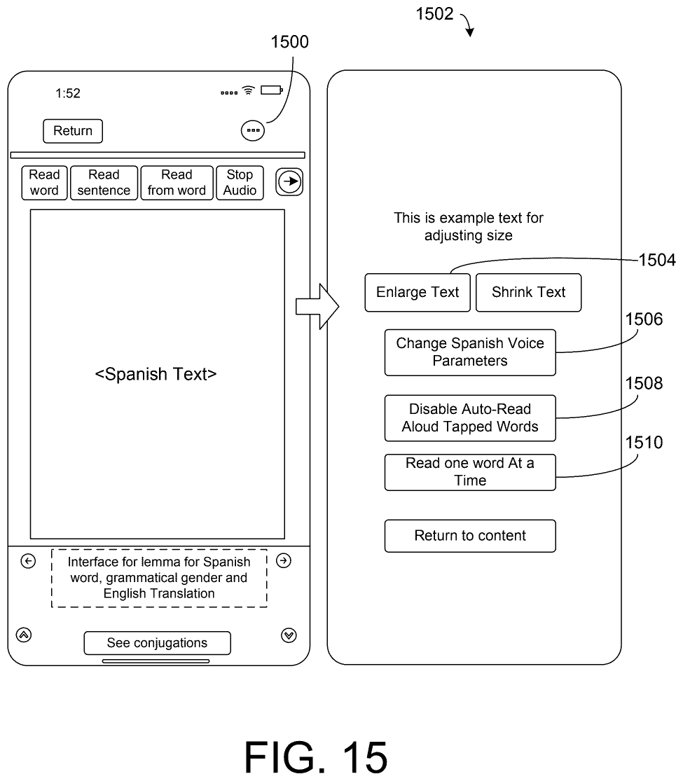

FIG. 15 depicts example screenshots of an embodiment of an interface for using tools 138 and modifying the parameters of other modules within the application. In some embodiments in some modules, in this example the interactive reader module 136, there may be control for accessing a menu for adjusting various settings 1502. Within this embodiment of this menu are controls for changing the size of the displayed text 1504, changing the target language TTS parameters 1506, and toggling various automatic features such as whether words are read aloud when tapped in the interactive reader module 1508. There may also be tools to change the TTS for the language through which the target language is learnt, the colors, fonts, and the like for the style of the application. There may also be options for further changes to the TTS capabilities such as whether it repeats whatever it reads at various speeds, pitches, accents and the like, whether it reads the entirety of the content including across multiple pages, whether it reads one word at a time with pauses or not 1510 and the like.

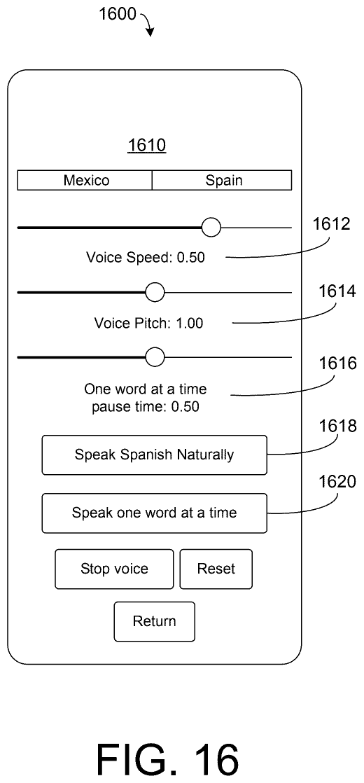

FIG. 16 is an example screenshot of an embodiment of a TTS parameter modifier interface 1600. In this embodiment, there are options between various accents of the language 1610, a way to modify the speed 1612 and pitch 1614 of the voice reading the content. In this example, these options are represented by slider controls. There is also a slider control for modifying the pauses while reading aloud when the TTS is being used to read one word at a time 1616. There is a control for hearing an example of the voice under the current parameters 1618 with the TTS reading an entire sentence at once where the voice speaks in a natural way and a control 1620 for hearing an example of the TTS voice speaking one word at a time with longer pauses between the words.

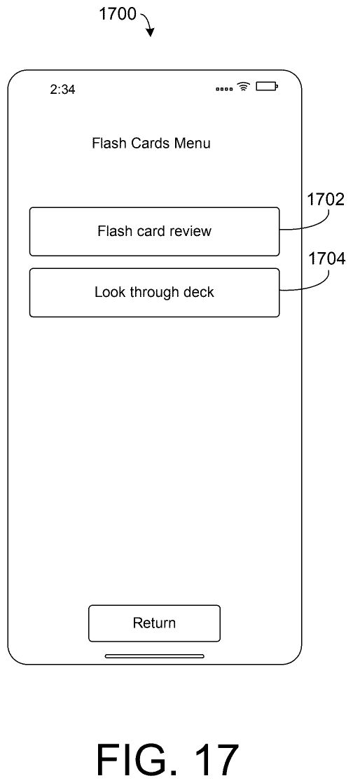

FIG. 17 is an example screenshot of an embodiment of a menu for interacting with virtual flash cards 1700. In this embodiment, the user can use a flash card review study tool 1702 or browse through their virtual deck freely 1704.

FIG. 18A is an example screenshot of an embodiment of a flash card review feature 1800. In this example, a virtual front side of a card 1802 is displayed and the virtual back side of the card is hidden until the user uses some control to show a hidden virtual back side of the card 1806. In some embodiments, the back side may be revealed automatically, manually, or triggered by another process. In some embodiments the virtual back side may be shown and the virtual front side hidden at first. Any combination of sides, including starting with different revealed sides from card to card in some determined fashion, or cards with more than two parts of information to be displayed or revealed in some sequence and the like and combinations with all previously mentioned methods may be included in some embodiments. The processor 172 may use an algorithm which will make cards appear more frequently if they are determined as harder to remember and less frequently when determined as easier to remember for the user based on the assessment of the user performed by the application's assessment engine 144. Within the review feature itself in one embodiment are several ratings the user can select to indicate they remember the word well 1808, poorly or not at all 1810, or with absolute ease and confidence 1812. The flash card review feature may also have filter settings to limit the cards that may be shown based on the determined frequency of use, and/or how advanced the words, phrases, concepts they represent and the like are determined to be 1814, on pre-determined and user-made “categories” 1816 and the like stored in the language repository 142. For example one category may be “Music”, and in this category would be cards with words, phrases, and the like related to music. The category filter, difficulty and/or rarity level and the like can be changed through an options menu 1818 in some embodiments. Other study tools 138 such as the conjugation table generator may be generated by the study materials generator 132 and incorporated into the flash card review interface 1820.

FIG. 18B is an example screenshot of an embodiment of a flash card review options menu 1822. In this embodiment of this menu the user can access submenus to change the category 1824 and rarity level 1826.

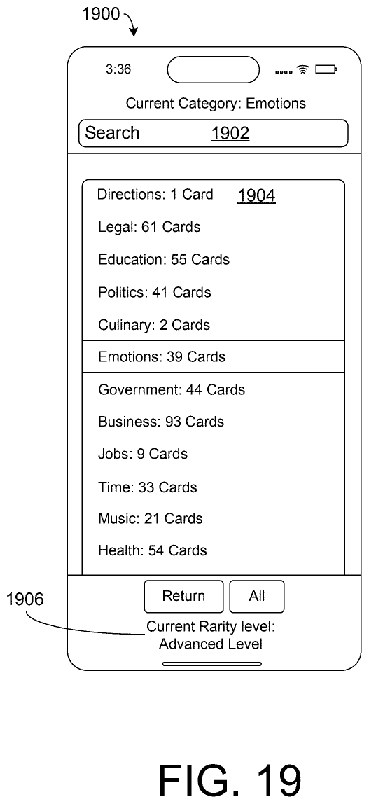

FIG. 19 is an example screenshot of an embodiment of the menu for selecting a category whose cards to which the user would like to restrict the flash card review 1900. In this embodiment, there is a search bar for narrowing down the displayed categories and counts next to each category specifying how many cards the user has in their deck in each category 1904 at the specific rarity level 1906. In this embodiment, the numbers do not include cards in the category that are beyond the current rarity/difficulty level.

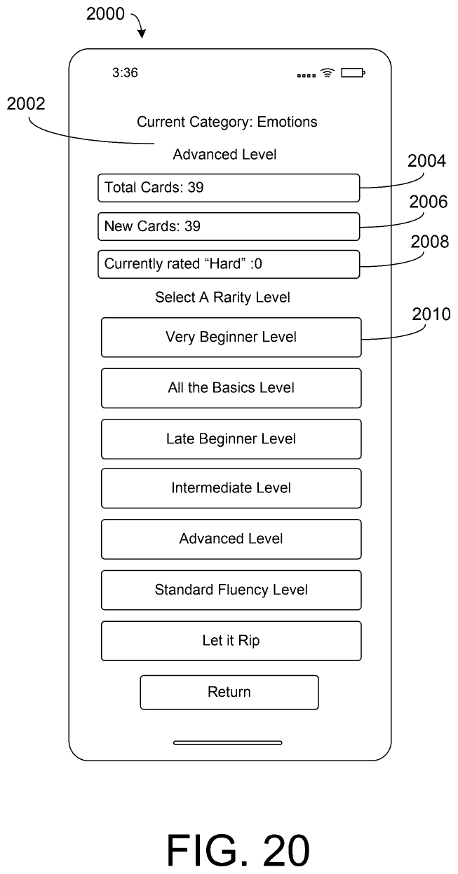

FIG. 20 is an example screenshot of an embodiment of a rarity level selection menu 2000. This view is an example of displaying summaries of the user's confidence with words and phrases determined by the assessment engine 144 and stored in memory 174 and/or in a cloud database 104. In this view is displayed the current rarity/difficulty level 2002 followed by the total number of cards up to this rarity/difficulty level under the current category 2004, the cards in this category up to the rarity/difficulty level that the user has never reviewed 2006 and that are determined to be difficult for the user 2008. The user can change their current rarity/difficulty level to one of various levels 2010. In some embodiments, the rarity/difficulty level may be an upper limit which permits all cards from the most common to some determined rarity/difficulty to be allowed by the processor to appear during flash card review. In some embodiments there may be an option to filter for bands of rarities/difficulties; excluding both more common and/or less complex words or phrases and possibly rare and/or more difficult words or phrases outside of said band.

FIG. 21 depicts a set of example screenshots of an embodiment of an interface 2100 for looking through a deck of flash cards. In this embodiment, there are search bars for both the target language 2102 and the language the target language is being learned through 2104 which narrows down the cards shown from the user's deck 2106. In this embodiment, the cards can be filtered by rarity level 2108 with an interactive picker and by category 2110. In this embodiment, the filter by category leads to the same menu whose embodiment is shown in FIG. 18A. 2112 is an embodiment of a view of the user's cards filtered to be restricted to the category of Architecture with no rarity restriction. In some embodiments the user's cards are color coded in coordination with the user's determined level of confidence with each card. In this embodiment, words the user has utmost confidence would be highlighted yellow 2114, the ones with a high level of confidence green 2116, the ones with a low level of confidence red 2118, and ones never reviewed light blue 2120. In this embodiment, the user can create their own cards 2122 and examine selected cards further 2124. In some embodiments a similar view exists for all words, phrases and the like in the language database.

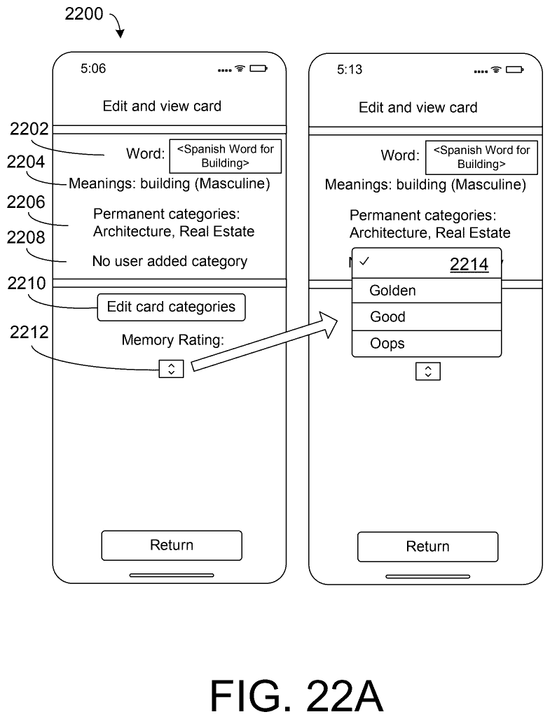

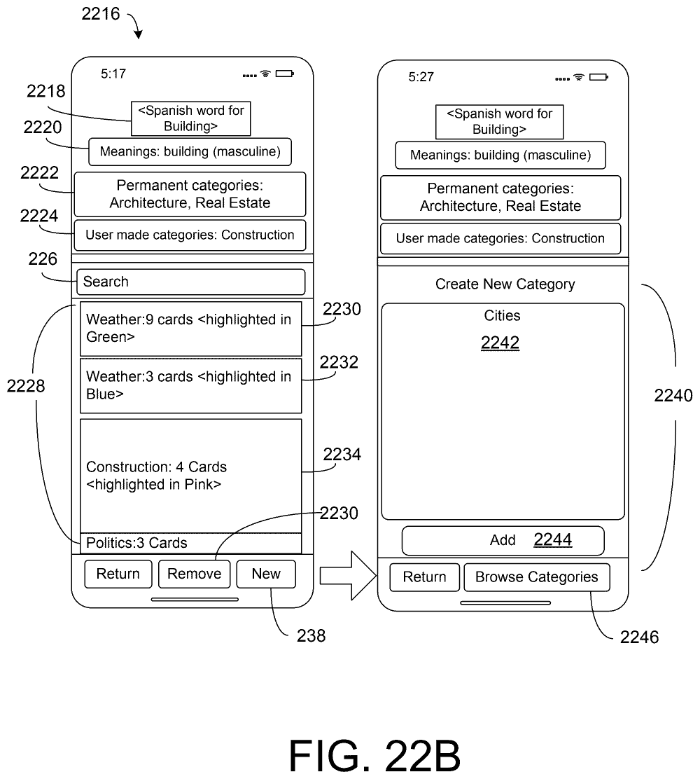

FIG. 22A depicts example screenshots of an embodiment of a card editing menu 2200. In this embodiment, the card shown is one whose front side text 2202 and back side text 2204 cannot be changed and which also is in two categories from which it cannot be removed 2206. In this embodiment, the user-added categories are also displayed, if any 2208. The user can add categories that this card is in using the module accessed by 2210. In this embodiment, the user can tell the processor how confident they are with the contents of this card using the picker 2212, 2214.

FIG. 22B depicts example screenshots of an embodiment of a menu for editing the categories for a flash card 2216. In this embodiment, the front side 2218, back side 2220, immutable categories 2222, and user made or added categories 2224 are displayed. In this embodiment, there is a scrollable list of categories 2228 which also shows the total number of cards already in each of those categories in the user's deck. In this embodiment, categories that the card is currently in are highlighted or otherwise marked to indicate inclusion (e.g., card 2230 is shown <highlighted in green>, categories that the card is in but cannot be taken out of are highlighted or otherwise marked to indicate an inability to remove the card (e.g., card 2232 is shown <highlighted in blue>, and categories the user has put the card into are highlighted or otherwise marked to indicate user addition of the card (e.g., card 2234 is shown <highlighted in pink>. In this embodiment, the user can remove the card from categories they added the card into 2236 and use a control to access a menu to create a new category 2238. This menu 2240 has a text input field 2242 where the user can create any category they wish, provided it doesn't already exist with a control 2244. In this embodiment, they can switch back to browsing through the existing categories as well 2246.

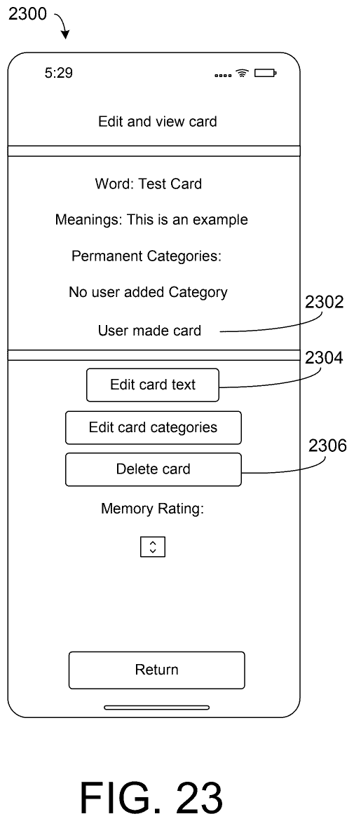

FIG. 23 is an example screenshot of an embodiment of a menu for editing and viewing a card all aspects of which the user is permitted to change 2300. It has all the same features as the embodiment shown in FIG. 22A along with some additional features. In this embodiment, it is explicitly labeled a user made card 2302, and the user can edit the text 2304 and even delete the card 2306. In some embodiments the user may be able to edit all properties of all cards in their deck, including removing them.

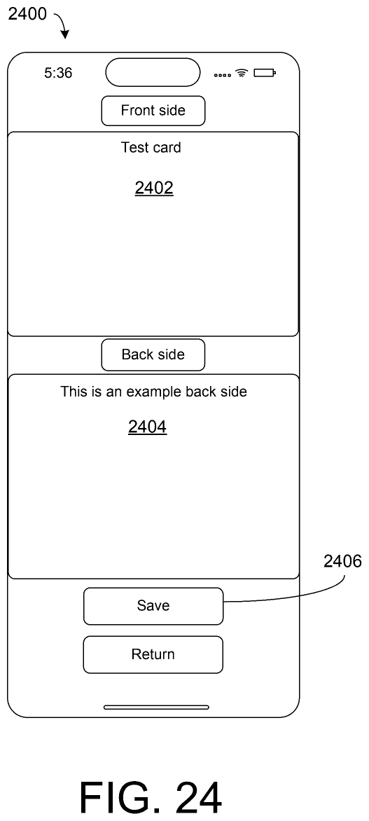

FIG. 24 is an example screenshot of an embodiment for a card text editor and/or creator interface 2400. In this embodiment, there are text input fields for both the front side text 2402 and back side text 2404 of the card, which can be saved 2406.

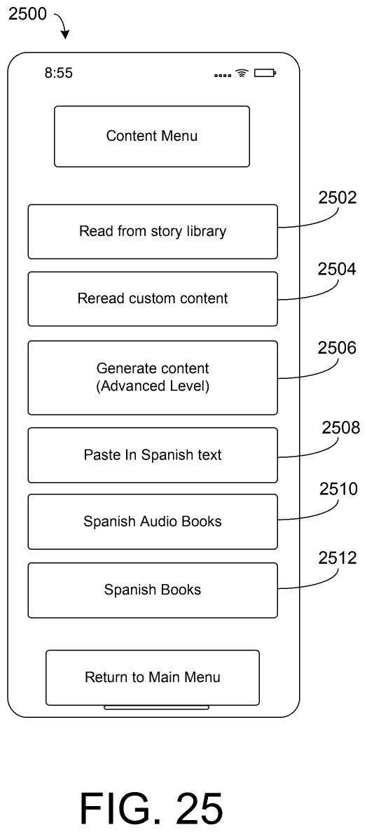

FIG. 25 is an example screenshot of an embodiment of a content menu, which may be accessed from a higher menu such as through 206. In this embodiment, the user may be able to access text, audio 2510, and video from the internet or content already downloaded onto their device from the cloud including content available to all users 2502 and content the AI content generator 130 created for them personally in the past 2504 which is stored locally 140 and/or in the cloud database 104. In this embodiment, a menu 2506 for creating prompts for the AI content generator 130 which are not explicitly related to any one lesson. Larger forms of text, such as books 2512 may be organized in their own section for clarity and organizational purposes. There may also be a control to access a view 2508 where the user may also be able to enter in any text whatsoever and read it with the benefits of the interactive reader module 136 and all the accompanying tools 138 and resources generated by the application 132.

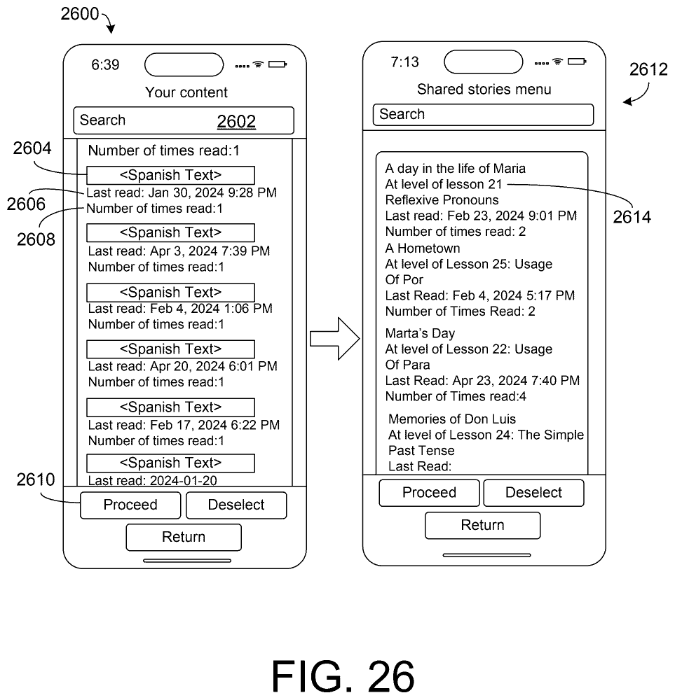

FIG. 26 depicts example screenshots of an embodiment of content library menus where saved content 140 and common content 118 may be perused. In one embodiment, a library of the user's previously created content 2600 can be scrolled through and browsed using a search function 2602. In this embodiment, the first several words of each instance of content 2604, the last time the user viewed the content 2606, and the total number of views for each 2608 are shown. Users can select the content and view it again 2610 in the interactive reader module 136. In some embodiments of a shared stories menu available to all users 2612 of the application, there are also timestamps for the last times read, number of times read, and in this embodiment titles instead of the first few words. In this embodiment, an associated lesson, if there is one, is shown 2614. In some embodiments users may be able to give titles to custom content created for them as well, and the first few words or more of pre-written content and user generated content may be viewable. In some embodiments custom content that is related to some lesson may also be labeled as related to said lesson.

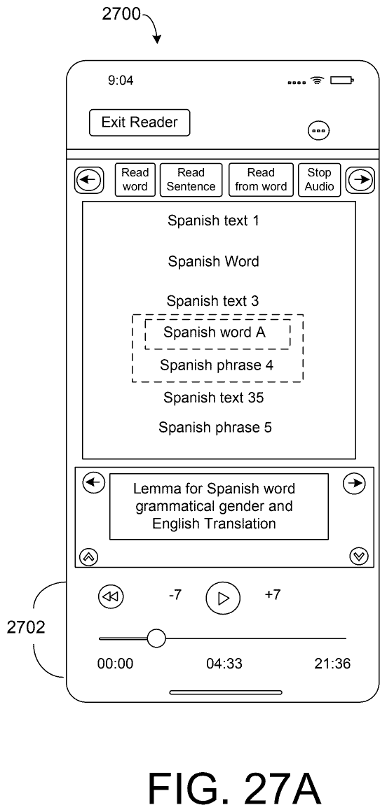

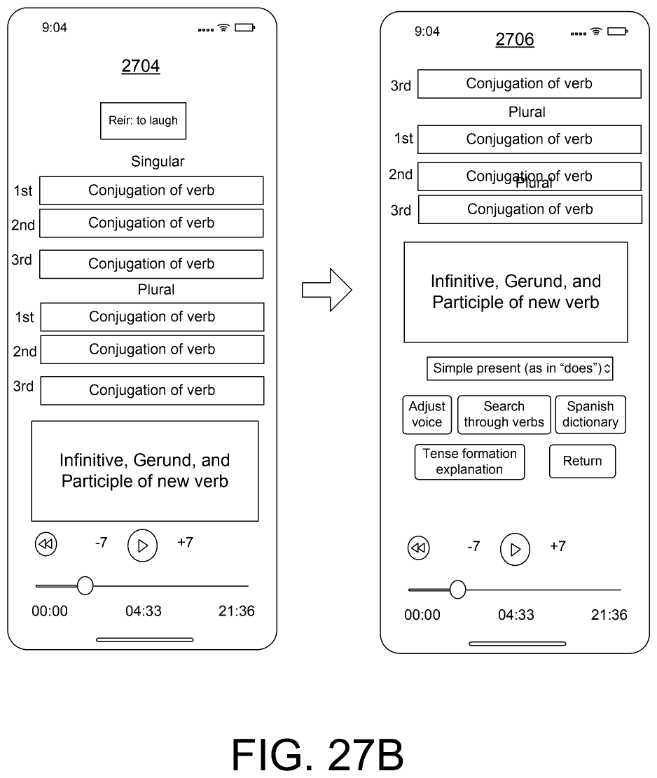

FIG. 27A is an example screenshot of an embodiment of the interactive reader module in combination with an audio player. The interactive reader module with all its features are still present but now with an audio player incorporated 2702.

FIG. 27B depicts example screenshots of an embodiment of the study tools and other tools incorporated into a scrollable view with an interactive reader module which is paired with an audio player 2704. The tool remains at a scale that retains its readability and can be scrolled through rapidly to access all its tools 2706.

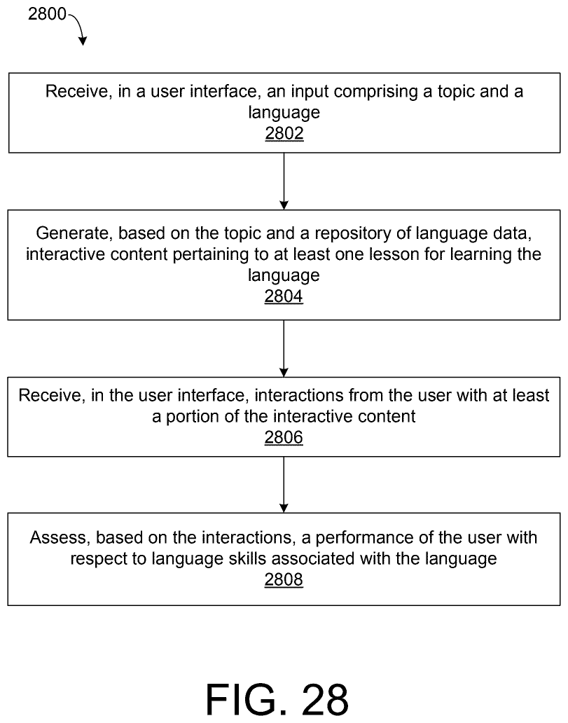

FIG. 28 is a flow chart depicting a process 2800 for generating and displaying content in an adaptive language learning system. In general, the process 2800 may be a computer-implemented method that may assess skills, levels, and/or abilities of a user (e.g., using a user assessment engine 144), and in response, generate or update user-specific content to enable the user to progressively learn skills pertaining to language. The process 2800 may be operated and/or otherwise accessed within application 106. Application 106 may utilize processor 172 and memory 174 to execute steps of the process 2800. Application 106 may incorporate data and/or programmed logic and/or output from AI content generator 130, user assessment engine 144, AI/ML models 146, common data 118, user data 114, server data and/or instructions from server 104, saved content 140, and/or language repository 142 to carry out any or all of the steps of process 2800. In addition, application 106 may generate study materials using study materials generator 132. Application 106 may additionally generate content using AI content generator 130 and/or study materials generator 132.

At block 2802, the process 2800 includes receiving an input (e.g., input(s) 115) from a user in a user interface. For example, the input 115 may represent one or more of: a user entered textual, visual, or audial input; input generated by AI; a previously generated input; or the like. In some embodiments, the input 115 may be curated to help produce content of a specific style or level associated with a user interface or application. In some embodiments, the user interface may be part of application 106. For example, the input 115 may include a topic (e.g., topic(s) 115) and a language (e.g., language 117). For example, a user may input a topic and a language into a user interface presented by application 106. The topic and language may pertain to a topic and language that the user is attempting to learn. The topic may include one or more topics in which the user has interest. The learning environment 100 may use such topics and language to generate content in which the user is interested in learning while using the learning environment 100 to learn the new language. In general, the input 115 may include content and/or instructions with characters, text, audio, and/or visual data that indicates an interest of the user in a particular topic (or set of topics), which may be used by environment 100 to generate language learning content that is curated to a user-specific learning level for the entered language.

The input 115 provided to the user interface of application 106, for example, may include instructions and/or prompts for the AI/ML model 146 to generate content. The input may include a tone or emotional quality of the content, a style of the content, a length of the content, or other request that may format, curate, or otherwise manage the retrieval and display of content. In some embodiments, the input may include one or more other requests for obtaining and displaying content that may include indicated characters of a provided content, plot twists, or a series of sequential explanations on a complex topic.

At block 2804, the process 2800 includes generating interactive content pertaining to at least one lesson for learning the language. The interactive content may be based on the topic and on a repository (e.g., language repository 142) of language data that includes rules and/or collections of words and phrases associated with the language. The topic may be associated with a particular lesson being accessed in application 106. In some embodiments, the topic may not be associated with the lesson being accessed and may instead pertain to a topic of interest to the user. In some embodiments, the AI content generator 130 may generate content and/or interactive content about the user-entered topic (or other input from input 115). In some embodiments, the application 106 may generate interactive data without the AI content generator 130 utilizing UI generator 134, study materials generator 132, and/or interactive reader module 136. To generate such content, the AI content generator 130 (and/or application 106) may utilize language repository 142, tools 138, and/or AI/ML models 146.

The repository of language data (e.g., language repository 142) for collections of words and phrases associated with the language is generated by an artificial intelligence model (e.g., AI model 146). The repository 142 may include data indicating a frequency of use of one or more word or phrase in the collections of words and phrases; data indicating a determined level of confidence of the user for one or more of the collections of words and phrases; definition data for one or more of the collections of words and phrases; and/or data indicating related topics to one or more of the collections of words and phrases.

In general, the AI/ML model(s) are given user prompts which may be modified and appended to in order to produce outputs with improved quality. As an example, in a lesson teaching users how to speak about hypotheticals, the prompt given to the AI/ML model 146 may include “please include lots of hypotheticals.” As another example, a prompt may include “Here is an example of a quality content at the desired level of difficulty” followed by the at least one example of content that is determined to be of an appropriate level of difficulty. In a lesson which teaches a set of words, the prompt to AI can include “Please use the following words often.”

In some embodiments, the interactive content described herein includes instructional content and study materials associated with the at least one language lesson and modifying the suggested difficulty level includes modifying the difficulty level of content generated and suggested to the user for seeing examples of the concepts taught in the instructional content. For example, the determined recommendation for content may be modified to correspond to an increase in difficulty for one or more of vocabulary term, phrase, term form, or a combination thereof. For example, instructions appended onto prompts sent to a LLM for generating content may be changed from requesting content at a third grade reading level to a twelfth grade reading level.

In some embodiments, the portion of the instructional content and related content may be modified with a removal of a portion of interactive assistance. For example, the interactive assistance that corrects or provides answers may be removed for particular terms or lesson portions corresponding to the portion. In some embodiments where Japanese is being taught, this may include removing phonetic characters above words that indicate how they are read for words that are considered to be at a difficulty level below that of the user. In some embodiments, modifying the suggested difficulty level includes modifying at least a portion of content provided to the user with one or more of: an increase in difficulty for one or more of vocabulary term, phrase, term form, or a combination thereof, a removal of a portion of interactive assistance, and a removal of portions of the instructional content.

In some embodiments, the interactive content described herein includes instructional content and study materials associated with the at least one language lesson and the modified interactive content includes at least a portion of content presented to the user with a decrease in difficulty for one or more of vocabulary term, phrase, term form, or a combination thereof. In some embodiments, the modified interactive content includes adding interactive assistance. In some embodiments, the modified interactive content includes at least a portion of the content presented to the user being provided with additional instructional content or additional study materials. In some embodiments, the portion of content presented to the user may be modified with one or more of: a decrease in difficulty for one or more of vocabulary term, phrase, term form, or a combination thereof, an addition of interactive assistance, and additional instructional content or additional study materials.

At block 2806, the process 2800 includes receiving, in the user interface, interactions from the user with at least a portion of the interactive content. For example, a user may enter content or perform interactions with the interactive content by entering one or more: questions, keywords, phrases, symbols, requests, images, etc. in a user interface, such as input field 702 (FIG. 7A) (e.g., or other UI input portion, interactive content, or interactive control). For example, in some embodiments, the interactions may instead include input at one or more controls provided by UI generator 134.

For example, the user may provide information (e.g., interactions, input, etc.) to environment 100 by entering a rating for a level of understanding or experience with a particular word or phrase in a lesson. Another example of an interaction may include a user entering input into a UI provided by application 106 to rate their own level of understanding while reading content and/or lessons and/or at the end of a lesson. As another example, an interaction may include executing steps and tasks provided as part of a lesson provided by environment 100. One such example may include showing the user each of the words and phrases in a story in a flash card review module and calculating based on the user's rating of how well they can recall each word their overall understanding of the words used in the story. Another example may include showing the user the content with any or all of the words highlighted simultaneously using color, underlining, or the like to indicate the user's determined understanding of each word, phrase, or other sub portion of the content. The user may then be asked to rate their understanding of each, and the collection of their determined understanding of each used to determine the user's ability to understand the words, phrases, and grammar with the aid of context. In some embodiments, the user (e.g., a reader) may be asked to write something themselves in the target language which will then be passed to an LLM for an evaluation of their writing level.

At block 2808, the process 2800 includes determining a knowledge level of the user with respect to language skills associated with the language. In some embodiments, the determination may be based on the interactions. For example, determining the knowledge level of the user with respect to language skills associated with the language may include having the user assessment engine 144 assess the interactions performed by the user during lessons and/or study material interaction to ascertain a language skill level of the user. In some embodiments, this assessment can be used to determine whether or not to increase or decrease a difficulty of the interactive content being generated and/or provided to the user by environment 100. In some embodiments, if a user enters a determined confidence with respect to a flash card review session, for example, the environment 100 may automatically infer a language skill level from such a session because each virtual flash card may be associated with data for both a frequency of use and a difficulty of the associated word (or phrase or concept) in the language.

In some embodiments, determining the knowledge level of the user is based at least in part on one or both of: a user inputted rating of words or phrases within the interactive content and a user inputted rating of understanding of portions of the interactive content.

In some embodiments, the determination of the knowledge level may be based at least in part on the user entered ratings of the words and phrases in a flash card review or during use of other aspects of the application 106. In some embodiments, the determination of the knowledge level may be based at least in part on a user rating an understanding of content and that understanding rating may be associated with a particular difficulty level.

In some embodiments, the determination of the knowledge level may be based at least in part on a user inputted rating of understanding of portions of the interactive content. For example, the system 100 may receive a direct input from the user which indicates a difficulty rating that the user wishes to receive content. The system 100 may append additional instructions to a prompt provided to the environment 100 (e.g., AI, ML, or other model) to ensure provided content is provided according to the received knowledge level (and/or received difficulty level). The user may wish to enter a particular difficulty level to account for user experience. For example, a user may, at times, wish to read and/or listen to something at a lower level of difficulty to ensure a relaxed experience with the language learning as they may understand a larger portion of the language content. At other times, the user may wish to request a higher difficulty level to ensure that the content received is challenging, for example, to utilize the content as a test or exercise in language improvement.

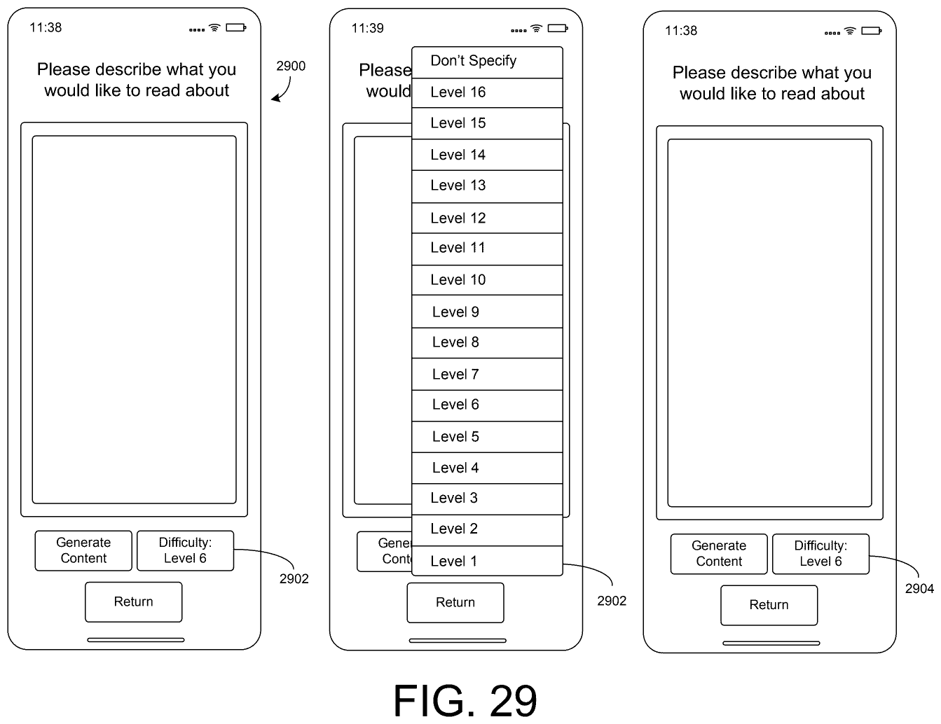

At block 2810, the process 2800 includes generating, based on the determined knowledge level, one or more selectable indications (as shown in FIG. 29). In some embodiments, an instance of a selectable indicator 2902 may be in a content creation menu 2900. The one or more selectable indications may include a suggested difficulty level at which to continue the at least one lesson or a suggested difficulty level for users to target when selecting content or requesting AI-generated supplemental content. The AI-generated supplemental content may include more or less advanced words, complex sentences, and the like depending on the determined or selected level of difficulty in the content request.

In some embodiments, the process 2800 may further include adaptively modifying the suggested difficulty level for the interactive content or the supplemental content, in response to receiving input at the control to change the suggested difficulty level or provide supplemental content for. For example, when the user opens the content creation menu the selectable indicator 2904 may be programmatically set to the determined level of the user.

In some embodiments, each lesson provided by environment 100 presupposes proficiency in the topics of all prior (e.g., earlier, less difficult) lessons, and content generated at the level of a lesson may include all concepts taught in all prior lessons. In some embodiments, the determined difficulty may be used in the context of a user-tailored content generator unrelated to any particular lesson. In this way, the user can be provided content at their specific language learning level without it necessarily being modified to emphasize the concepts taught in a particular lesson, thereby allowing the AI to increase its creativity by loosening the restrictions of its generated output (e.g., content, interactive content, etc.).

In some embodiments, the interactive content may include instructional content and study materials (e.g., flash cards, outlines, etc.) associated with the at least one language lesson. In some embodiments, the modified interactive content may include at least a portion of the instructional content with: an increase in difficulty for one or more of vocabulary term, phrase, term form, or a combination thereof, a removal of a portion of interactive assistance, or a removal of portions of the instructional content.

In some embodiments, the process 2800 may further utilize an interactive reader (e.g., interactive reader module 136) communicatively coupled to the artificial intelligence model 146. The interactive reader module 136 may analyze, based on the language, the generated interactive content to generate information about lemmas, definitions, grammatical function, and morphological characteristics. The interactive reader module 136 may also present related content in the user interface, based on the analyzation of the generated interactive content, in coordination with user gestures or in an automated progression over time through the at least one lesson. In some embodiments, the related content includes one or more of a conjugation of a word, a definition of a word, a grammatical gender of a word, a declension of a word, an audible utterance of one or more words, or a visual indicator on the one or more words. In some embodiments, the interactive reader module 136 also provides text to speech functions for output from application 106 in conjunction with the related content and the interactive content.

In some embodiments, the process 2800 may further utilize a study materials generator (e.g., generator 132) communicatively coupled to the artificial intelligence model 146. The study materials generator 132 may generate study materials responsive to user selection of a word, a phrase or a portion of content in the interactive content. In some embodiments, the study materials may include user interface content including dynamic explanations for grammar and word usage of the selected word, phrase, or portion of content, user interface content including tables indicating forms of the selected word or phrase, and/or one or more virtual flash cards. The one or more virtual flash cards (e.g., front side 510, back side 512) may be collected over time and presented to the user in the user interface (e.g., interface 508).

FIG. 29 is a set of example screenshots depicting a content creation menu 2900 with a selector 2902 for a target difficulty level of the content. In some embodiments, the default difficulty level may be set to one suggested by the program 2904.

The systems and methods described herein and variations thereof can be embodied and/or implemented at least in part as a machine configured to receive a computer-readable medium storing computer-readable instructions. The instructions may be executed by computer-executable components integrated with the system and one or more portions of the processor on the nasal assemblies described herein and/or computing devices 801. The computer-readable medium can be stored on any suitable computer-readable media such as RAMs, ROMs, flash memory, EEPROMs, optical devices (e.g., CD or DVD), hard drives, floppy drives, or any suitable device. The computer-executable component may include any suitable dedicated hardware or hardware/firmware combination that can alternatively or additionally execute the instructions.

References in the specification to “one embodiment,” “an embodiment,” “an illustrative embodiment,” “some embodiments,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used in the description and claims, the singular form “a”, “an” and “the” include both singular and plural references unless the context clearly dictates otherwise. For example, the term “sensor” may include, and is contemplated to include, a plurality of sensors. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An adaptive language learning system comprising:
at least one processor; and
memory storing instructions that when executed by the at least one processor cause the at least one processor to perform operations including:
receiving an input from a user in a user interface, the input comprising a topic and a language;
generating, based on the topic and a repository of language data having rules and collections of words and phrases associated with the language, interactive content pertaining to at least one lesson for learning the language;
receiving, in the user interface, interactions from the user with at least a portion of the interactive content;
determining, based on the interactions, a knowledge level of the user with respect to language skills associated with the language; and
generating, based on the determined knowledge level, one or more selectable indications comprising a suggested difficulty level at which to continue the at least one lesson or a suggested difficulty level for users to target when selecting content or requesting AI-generated supplemental content.

2. The system of claim 1, wherein determining the knowledge level of the user is based at least in part on one or both of:
a user inputted rating of words or phrases within the interactive content; and
a user inputted rating of understanding of portions of the interactive content.

3. The system of claim 1, further comprising:
modifying the suggested difficulty level for the interactive content or the supplemental content in response to receiving selection on the one or more selectable indications.

4. The system of claim 1, wherein the repository of language data for collections of words and phrases associated with the language is generated by an artificial intelligence model and includes data indicating a frequency of use of one or more word or phrase in the collections of words and phrases, data indicating a determined level of confidence of the user for one or more of the collections of words and phrases, definition data for one or more of the collections of words and phrases, and data indicating related topics to one or more of the collections of words and phrases.

5. The system of claim 1, further comprising an interactive reader communicatively coupled to an artificial intelligence model and configured to:
analyze, based on the language, the generated interactive content to generate information about lemmas, definitions, grammatical function, and morphological characteristics; and
present related content in the user interface, based on the analyzing of the generated interactive content, in coordination with user gestures or in an automated progression over time through the at least one lesson.

6. The system of claim 5, wherein the related content comprises one or more of: a conjugation of a word, a definition of a word, a grammatical gender of a word, a declension of a word, an audible utterance of one or more words, and a visual indicator on the one or more words, and wherein the interactive reader provides text to speech function for output in conjunction with the related content and the interactive content.

7. The system of claim 1, further comprising a study materials generator communicatively coupled to an artificial intelligence model configured to generate a plurality of study materials responsive to user selection of a word, a phrase, or a portion of content in the interactive content.

8. The system of claim 7, wherein the plurality of study materials comprise:
user interface content including dynamic explanations for grammar and word usage of the selected word, phrase, or portion of the generated supplemental content;
user interface content including tables indicating forms of the selected word or phrase; and
one or more virtual flash cards.

9. The system of claim 8, wherein the one or more virtual flash cards are collected over time and presented in the user interface.

10. A non-transitory computer-readable medium for teaching language in an adaptive language learning system, comprising:
at least one processor; and
a memory storing instructions that, when executed by the at least one processor, cause the at least one processor to perform operations comprising:
receiving an input from a user in a user interface, the input comprising a topic and a language;
generating, based on the topic and a repository of language data having rules and collections of words and phrases associated with the language, interactive content pertaining to at least one lesson for learning the language;
receiving, in the user interface, interactions from the user with at least a portion of the interactive content;
determining, based on the interactions, a knowledge level of the user with respect to language skills associated with the language; and
generating, based on the determined knowledge level, one or more selectable indications comprising a suggested difficulty level at which to continue the at least one lesson or a suggested difficulty level for users to target when selecting content or requesting AI-generated supplemental content.

11. The computer-readable medium of claim 10, wherein determining the knowledge level of the user is based at least in part on one or both of:
a user inputted rating of words or phrases within the interactive content; and
a user inputted rating of understanding of portions of the interactive content.

12. The computer-readable medium of claim 10, wherein the operations further comprise:
modifying the suggested difficulty level for the interactive content or the supplemental content in response to receiving selection on the one or more selectable indications.

13. The computer-readable medium of claim 10, wherein the repository of language data for collections of words and phrases associated with the language is generated by an artificial intelligence model and includes data indicating a frequency of use of one or more word or phrase in the collections of words and phrases, data indicating a determined level of confidence of the user for one or more of the collections of words and phrases, definition data for one or more of the collections of words and phrases, and data indicating related topics to one or more of the collections of words and phrases.

14. The computer-readable medium of claim 10, further comprising an interactive reader communicatively coupled to an artificial intelligence model and configured to:
analyze, based on the language, the generated interactive content to generate information about lemmas, definitions, grammatical function, and morphological characteristics; and
present related content in the user interface, based on the analyzing of the generated interactive content, in coordination with user gestures or in an automated progression over time through the at least one lesson.

15. The computer-readable medium of claim 14, wherein the related content comprises one or more of: a conjugation of a word, a definition of a word, a grammatical gender of a word, a declension of a word, an audible utterance of one or more words, and a visual indicator on the one or more words, and wherein the interactive reader provides text to speech function for output in conjunction with the related content and the interactive content.

16. A computer-implemented method for teaching language in an adaptive language learning system, the method comprising:
at least one processor; and
a memory storing instructions that, when executed by the at least one processor, cause the at least one processor to perform operations comprising:
receiving an input from a user in a user interface, the input comprising a topic and a language;
generating, based on the topic and a repository of language data having rules and collections of words and phrases associated with the language, interactive content pertaining to at least one lesson for learning the language;
receiving, in the user interface, interactions from the user with at least a portion of the interactive content;
determining, based on the interactions, a knowledge level of the user with respect to language skills associated with the language; and
generating, based on the determined knowledge level, one or more selectable indications comprising a suggested difficulty level at which to continue the at least one lesson or a suggested difficulty level for users to target when selecting content or requesting AI-generated supplemental content.

17. The computer-implemented method of claim 16, wherein determining the knowledge level of the user is based at least in part on one or both of:
a user inputted rating of words or phrases within the interactive content; and
a user inputted rating of understanding of portions of the interactive content.

18. The computer-implemented method of claim 16, wherein the operations further comprise:
modifying the suggested difficulty level for the interactive content or the supplemental content in response to receiving selection on the one or more selectable indications.

19. The computer-implemented method of claim 16, wherein the repository of language data for collections of words and phrases associated with the language is generated by an artificial intelligence model and includes data indicating a frequency of use of one or more word or phrase in the collections of words and phrases, data indicating a determined level of confidence of the user for one or more of the collections of words and phrases, definition data for one or more of the collections of words and phrases, and data indicating related topics to one or more of the collections of words and phrases.

20. The computer-implemented method of claim 16, further comprising an interactive reader communicatively coupled to an artificial intelligence model and configured to:
analyze, based on the language, the generated interactive content to generate information about lemmas, definitions, grammatical function, and morphological characteristics; and
present related content in the user interface, based on the analyzing of the generated interactive content, in coordination with user gestures or in an automated progression over time through the at least one lesson.

21. The computer-implemented method of claim 20, wherein the related content comprises one or more of: a conjugation of a word, a definition of a word, a grammatical gender of a word, a declension of a word, an audible utterance of one or more words, and a visual indicator on the one or more words, and wherein the interactive reader provides text to speech function for output in conjunction with the related content and the interactive content.

22. The computer-implemented method of claim 16, further comprising a study materials generator communicatively coupled to an artificial intelligence model configured to generate a plurality of study materials responsive to user selection of a word, a phrase, or a portion of content in the interactive content.
